(19) United States
(12) Patent Application Publication
(10) Pub. No.: US 2006/0126088 A1
(43) Pub. Date: Jun. 15, 2006

(54) Information processing apparatus and method, and program

(76) Inventors: Masayuki Inoue, Tokyo (JP); Katsuro Matsuzaki, Kanagawa (JP); Kanako Nakamura, Tokyo (JP); Shinji Sakai, Tokyo (JP)

Correspondence Address: FROMMER LAWRENCE & HAUG LLP, 745 FIFTH AVENUE, NEW YORK, NY, 10151, US

(21) Appl. No.: 11/296,417

(22) Filed: Dec. 7, 2005

(30) Foreign Application Priority Data
Dec. 9, 2004 (JP) 2004-356210

(51) Int. Cl. G06K 15/00

(52) U.S. Cl. 358/1.12; 358/1.18

(57) ABSTRACT

An information processing apparatus and method and a program are disclosed wherein a plurality of data can be successively outputted continuously and stably without a delay at output timings scheduled in advance without increasing the cost. When the number of image data whose status is “image decoding completed” is insufficient with respect to a request from an effect image processing section, that is, when the decoding process by a decoding processing section delays with respect to the progress of slideshow, an image data management section supplies image data whose status is “cache” and which have been outputted formerly to the effect image processing section again. The invention can be applied to various apparatus such as a personal computer which can handle still pictures.

### CROSS REFERENCES TO RELATED APPLICATIONS

The present invention contains subject matter related to Japanese Patent Application 2004-356210 filed with the Japanese Patent Office on Dec. 9, 2004, the entire contents of which being incorporated herein by reference.

### BACKGROUND OF THE INVENTION

This invention relates to an information processing apparatus and method and a program, and more particularly to an information processing apparatus and method and a program wherein a plurality of data are successively outputted continuously at output timings scheduled in advance.

A slideshow function of automatically displaying still pictures in order after every predetermined interval of time such as one second is incorporated in various apparatus such as a personal computer which can handle still pictures picked up by a digital camera. In some of such apparatus, a tune to be used as BGM upon slideshow can be selected in accordance with a liking of its user.

Consequently, the user can enjoy still pictures, which are displayed automatically and successively, while enjoying a favorite tune without performing any operation for causing the still pictures to be displayed one by one.

Also an apparatus is available which has a slideshow function which does not display still pictures (picked up still pictures) fetched by the apparatus as they are but successively displays still pictures to which various effects are applied (refer to, for example, “DoCoMo mova P506iC Photococktail (trademark)”, Internet <URL: http://panasonic.jp/mobile/p506ic/photo/index.html>: hereinafter referred to as Non-Patent Document 1).

In this instance, the user can select still pictures to be reproduced, a type of an effect and a tune of BGM to produce a content with BGM with which the still pictures to which the effect is applied can be displayed automatically and successively.

Further, a system for scheduling and processing image data and sound data has been proposed (for example, refer to JP-A-2001-507471, hereinafter referred to as Patent Document 1).

However, for example, in such an information processing apparatus wherein a slideshow application operates as disclosed in Non-Patent Document 1 and such a system as disclosed in Patent Document 1, it is necessary for a plurality of still pictures (frame images) to which an effect is applied to be displayed successively and continuously at predetermined timings on a monitor. In this instance, however, there is the possibility that, depending upon the capacity of the apparatus or the condition of the process, a decoding process and so forth of image data may not follow up the progressing timings of the slideshow, resulting in delay of the display of the still pictures.

If such delay as just mentioned occurs, then the displaying interval of the frame images cannot be controlled any more. This makes the motion of the displayed image displayed as moving pictures unnatural and makes the synchronism between image displaying and outputting of BGM difficult. This deteriorates the degree of satisfaction of the user with the slideshow.

In this manner, an information processing apparatus which, for example, does not have a sufficient image processing capacity has a subject to be solved in that slideshow images cannot be outputted in a stabilized state. On the contrary, in order to reduce such a state as just described to make it possible to output slideshow images in a stabilized state, the information processing apparatus must have a sufficient image processing capacity. Since this increases the circuit scale of the information processing apparatus, there is a subject in that also the fabrication cost and the service cost increase.

### SUMMARY OF THE INVENTION

It is a desire of the present invention to provide an information processing apparatus and method and a program wherein a plurality of data can be successively outputted continuously and stably without a delay at output timings scheduled in advance without increasing the cost.

In order to attain the desire described above, according to an embodiment of the present invention, there is provided an information processing apparatus for processing image data, including a reproduction control section for controlling image data so as to be reproduced successively at predetermined timings determined in advance, a storage section for storing first image data before reproduced by the reproduction control section and second image data after reproduced by the reproduction control section, and an image data management section for managing inputting and outputting of the image data stored in the storage section and supplying the first image data stored in the storage section to the reproduction control section but supplying, where the number of first image data to be supplied to the reproduction control section is insufficient, the second image data to the reproduction control section.

According to another embodiment of the present invention, there is provided an information processing method for an information processing apparatus for processing image data, including the steps of: controlling a reproduction section of the information processing apparatus to reproduce image data successively at predetermined timing determined in advance; and managing inputting and outputting of the image data stored in a storage section adapted to store first image data before reproduced by the process of the reproduction control step and second image data after reproduced by the process of the reproduction control step and supplying the first image data stored in the storage section to the reproduction section but supplying, where the number of the first image data to be supplied to the reproduction section is insufficient, the second image data to the reproduction section.

According to a further embodiment of the present invention, there is provided a program for causing a computer to perform a process regarding image data, including the steps of: controlling a reproduction section connected to the computer to reproduce image data successively at predetermined timing determined in advance; and managing inputting and outputting of the image data stored in a storage section of the computer adapted to store first image data before reproduced by the process of the reproduction control step and second image data after reproduced by the process of the reproduction control step and supplying the first image data stored in the storage section to the reproduction section but supplying, where the number of the first image data to be supplied to the reproduction section is insufficient, the second image data to the reproduction section.

In the information processing apparatus and method and the program, image data are controlled so as to be outputted successively at predetermined timings determined in advance, and the first image data before outputted and the second image data after outputted are stored. Inputting and outputting of the stored image data are managed, and the first image data stored are supplied. When the number of the first image data to be supplied is insufficient, the second image data are supplied.

With the information processing apparatus and method and the program, a plurality of data can be successively outputted continuously and stably without any delay at output timings scheduled in advance without increasing the cost.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a schematic view showing an example of an appearance of an information processing apparatus to which the present invention is applied and a television receiver;

FIGS. 2A and 2B are views illustrating an example of an effect;

FIG. 3 is a view showing an example of a play list;

FIG. 4 is a view showing an example of a template;

FIG. 5 is a block diagram showing an example of a configuration of the information processing apparatus;

FIG. 6 is a block diagram showing an example of a functional configuration of the information processing apparatus;

FIG. 7 is a block diagram showing an example of a configuration of a reproduction section shown in FIG. 6;

FIG. 8 is a block diagram showing an example of a configuration of a storage region of an internal memory shown in FIG. 7;

FIG. 9 is a flow chart illustrating a buffer management process;

FIG. 10 is a flow chart illustrating an image data management process;

FIG. 11 is a flow chart illustrating a status management process;

FIGS. 12A to 12C are schematic views illustrating an example of transition of the status;

FIGS. 13A to 13C are schematic views illustrating another example of transition of the status;

FIG. 14 is a schematic view showing an example of a menu screen;

FIG. 15 is a similar view but showing another example of the menu screen;

FIGS. 16 to 18 are flow charts illustrating a play list production process of the information processing apparatus;

FIG. 19 is a schematic view showing an example of a display screen;

FIGS. 20 to 23 are schematic views showing different examples of the display screen;

FIG. 24 is a flow chart illustrating details of the play list production process;

FIG. 25 is a flow chart illustrating details of a preview reproduction process;

FIG. 26 is a flow chart illustrating details of a slideshow content production process;

FIG. 27 is a flow chart illustrating a play list reproduction process of the information processing apparatus; and

FIG. 28 is a flow chart illustrating a slideshow content reproduction process of the information processing apparatus.

### DETAILED DESCRIPTION OF THE PREFERRED EMBODIMENTS

Before a preferred embodiment of the present invention is described in detail, a corresponding relationship between several features recited in the accompanying claims and particular elements of the preferred embodiment described below is described. The description, however, is merely for the confirmation that the particular elements which support the invention as recited in the claims are disclosed in the description of the embodiment of the present invention. Accordingly, even if some particular element which is recited in description of the embodiment is not recited as one of the features in the following description, this does not signify that the particular element does not correspond to the feature. On the contrary, even if some particular element is recited as an element corresponding to one of the features, this does not signify that the element does not correspond to any other feature than the element.

Further, the following description does not signify that the prevent invention corresponding to particular elements described in the embodiment of the present invention is all described in the claims. In other words, the following description does not deny the presence of an invention which corresponds to a particular element described in the description of the embodiment of the present invention but is not recited in the claims, that is, the description does not deny the presence of an invention which may be filed for patent in a divisional patent application or may be additionally included into the present patent application as a result of later amendment to the claims.

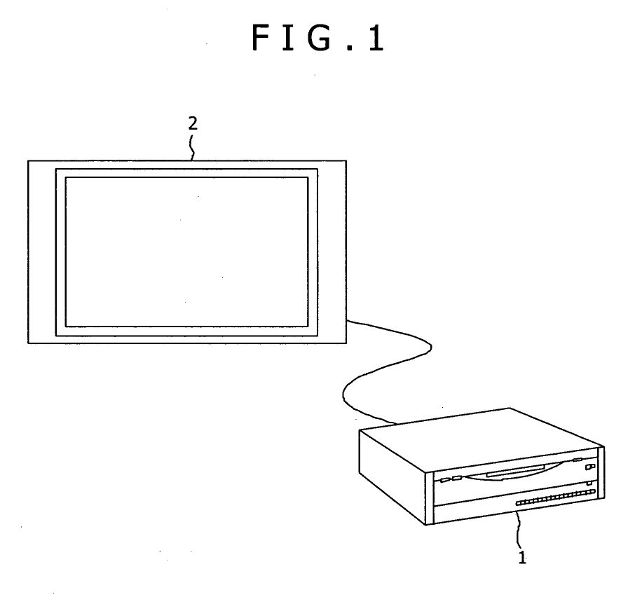

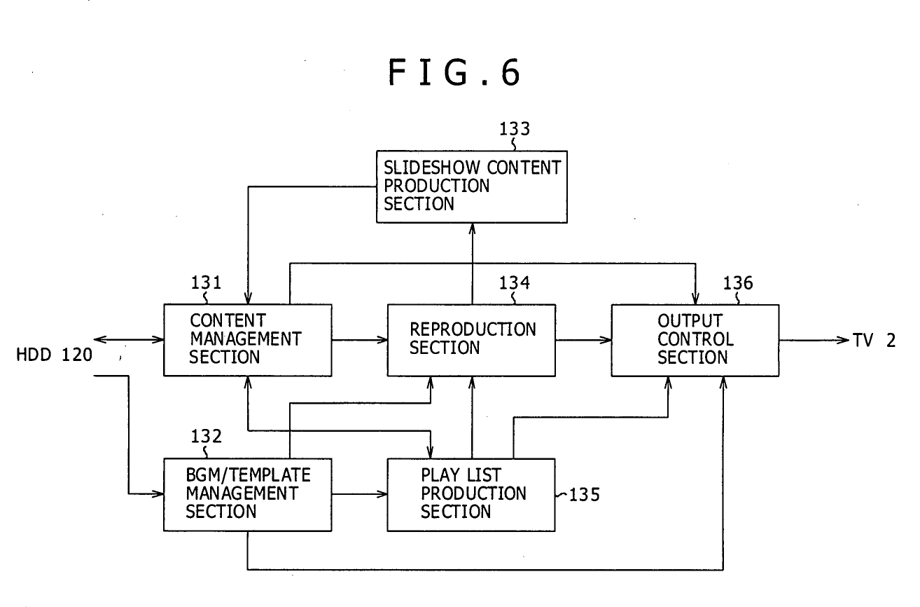

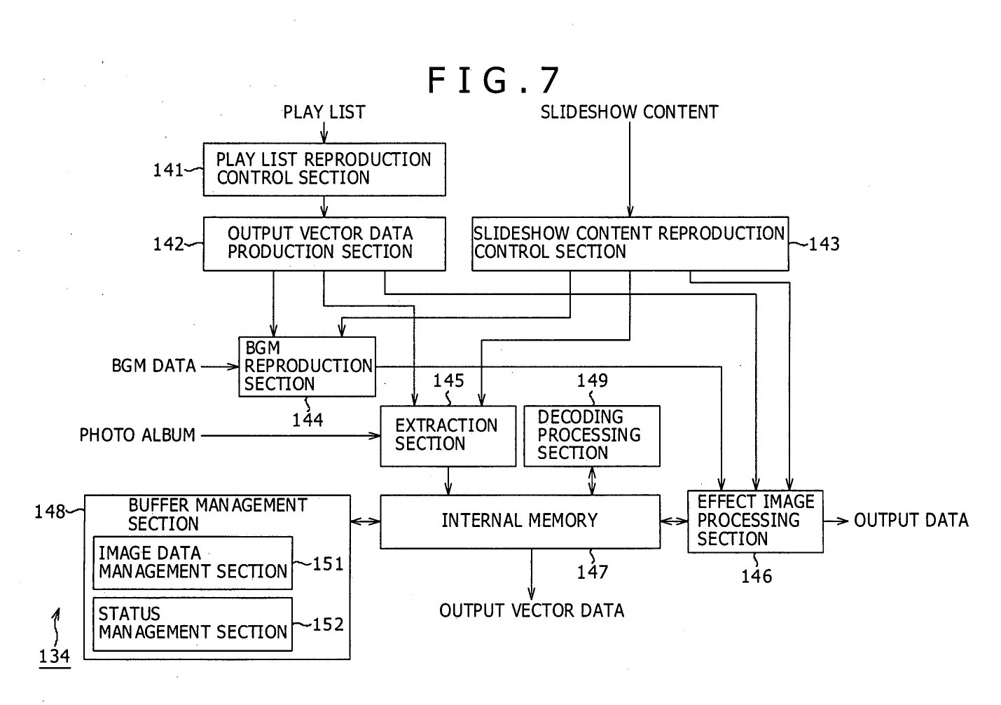

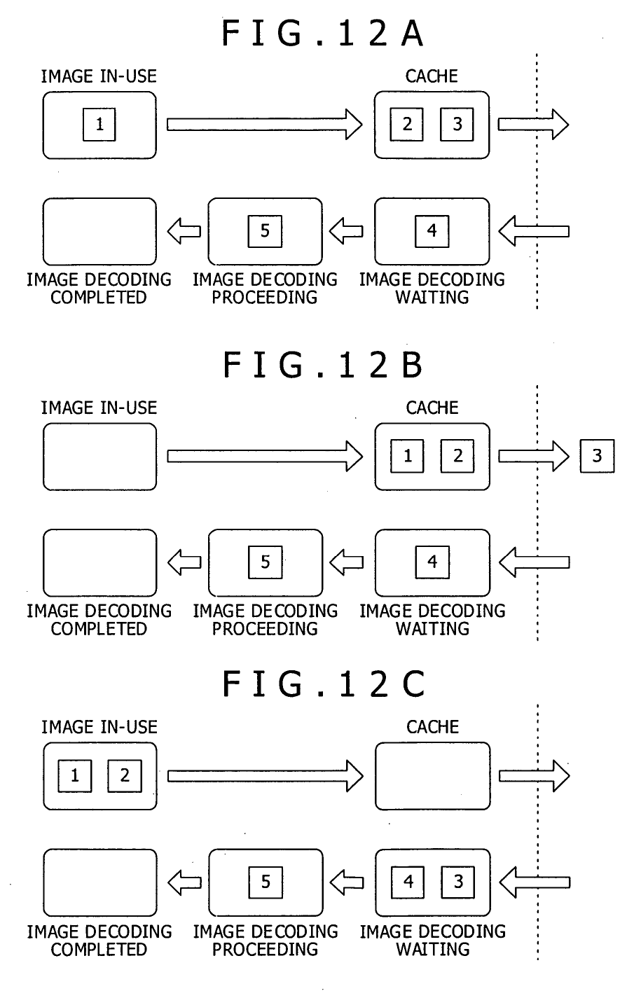

According to an embodiment of the present invention, an information processing apparatus (for example, an information processing apparatus 1 in FIG. 1) for processing image data is provided. The information processing apparatus includes a reproduction control section (for example, a reproduction section 134 of FIG. 6) for controlling image data so as to be reproduced successively at predetermined timings determined in advance, a storage section (for example, an internal memory 147 of FIG. 7) for storing first image data (for example, image data whose status is “image decoding completed” in FIG. 12) before reproduced by the reproduction control section and second image data (for example, image data whose status is “cache” in FIG. 12) after reproduced by the reproduction control section, and an image data management section (for example, a buffer management section 148 of FIG. 7) for managing inputting and outputting of the image data stored in the storage section and supplying the first image data stored in the storage section to the reproduction control section but supplying, where the number of first image data to be supplied to the reproduction control section is insufficient, the second image data to the reproduction control section.

The information processing apparatus may further include a setting section (for example, an image data management section 151 of FIG. 7) for setting a maximum total number of the first and second image data which can be stored in the storage section and a maximum number of the second image data which can be stored in the storage section, the image data management section managing inputting and outputting of the image data stored in the storage section so that the number of the stored image data may not exceed the maximum number set by the setting section.

The information processing apparatus may further include a decoding section (for example, a decoding processing section 149 of FIG. 7) for decoding image data encoded in accordance with a predetermined system, the image data management section causing the storage section to store the image data decoded by the decoding section as the first image data.

The information processing apparatus may further include a status management section (for example, a status management section 152 of FIG. 7) for managing transition of the status (for example, status 182-1 to 182-5 of FIG. 8) of the image data stored in the storage section, the status management section setting the statuses of the first and second data so as to be different from each other, the image data management section identifying the first and second data from each other based on the statuses.

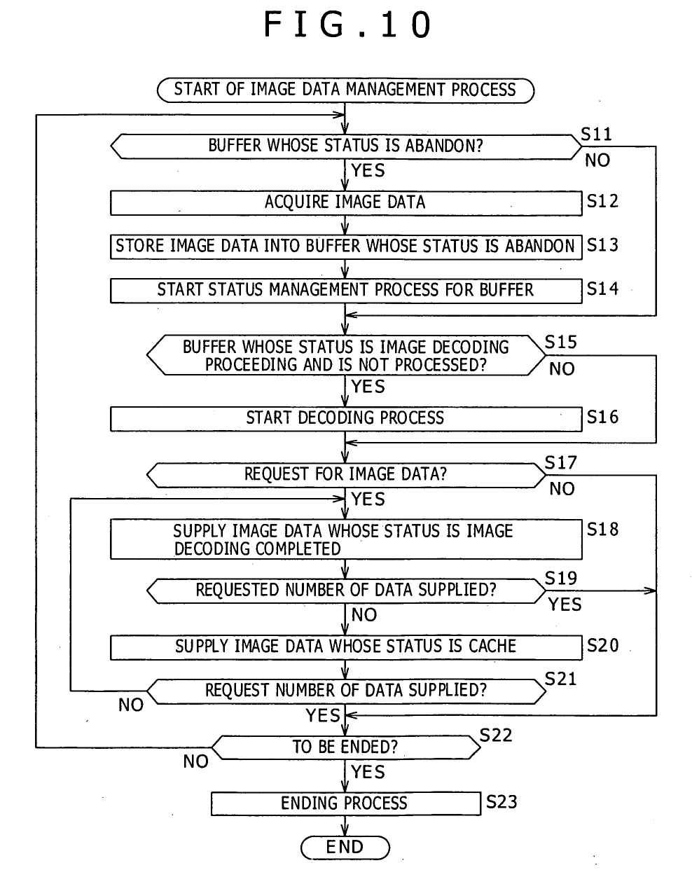

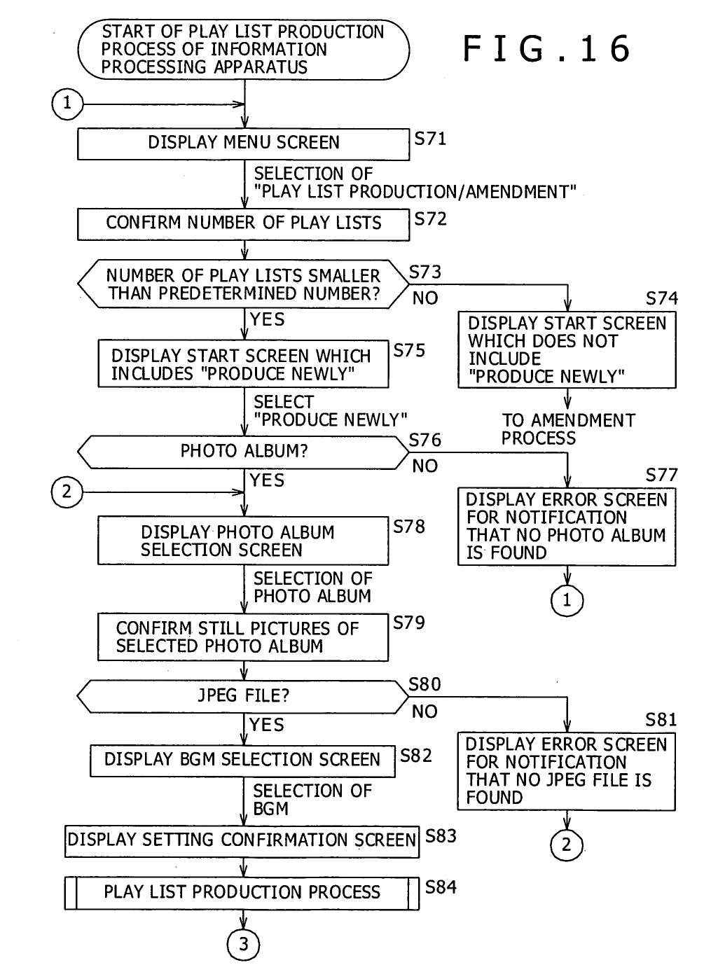

According to another embodiment of the present invention, an information processing method for an information processing apparatus (for example, an information processing apparatus 1 of FIG. 1) for processing image data is provided. The information processing method includes the steps of: controlling (for example, a play list production process of FIGS. 16 to 18) a reproduction section (for example, a reproduction section 134 of FIG. 6) of the information processing apparatus to reproduce image data successively at predetermined timing determined in advance; and managing (for example, an image data management process of FIG. 10) inputting and outputting of the image data stored in a storage section (for example, an internal memory 147 of FIG. 7) adapted to store first image data (for example, image data whose status is “image decoding completed” in FIG. 12) before reproduced by the process of the reproduction control step and second image data (for example, image data whose status is “cache” in FIG. 12) after reproduced by the process of the reproduction control step and supplying the first image data stored in the storage section to the reproduction section but supplying, where the number of the first image data to be supplied to the reproduction section is insufficient, the second image data to the reproduction section.

According to a further embodiment of the present invention, there is provided a program which includes steps similar to those of the information processing method described above.

In the following, an embodiment of the present invention is described with reference to the drawings.

FIG. 1 shows an example of an appearance of an information processing apparatus 1 to which the present invention is applied and a television receiver 2 (referred to the the TV2 hereinafter) connected to the information processing apparatus 1 through a cable.

The information processing apparatus 1 has a function for fetching still pictures picked up by a digital camera or the like into a built-in HDD (Hard Disk Drive) through a memory card, a USB (Universal Serial Bus) cable or the like and displaying the still pictures on the TV2. The information processing apparatus 1 performs slideshow for automatically and successively displaying (without depending upon any operation of the user) still pictures to which various effects are applied while a tune selected by the user is being played as BGM.

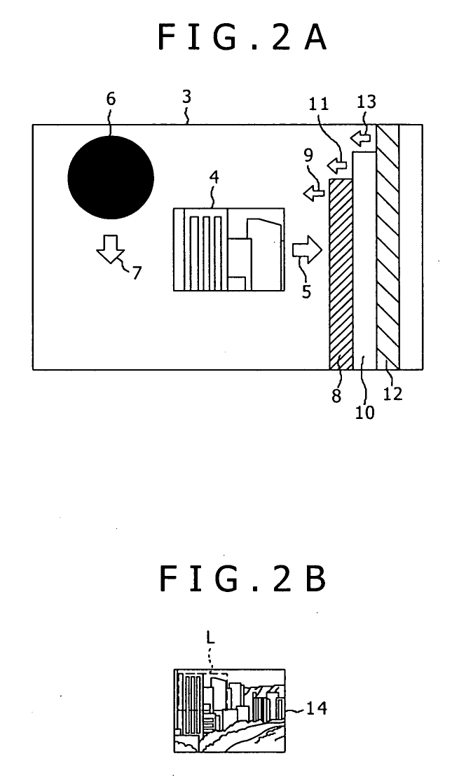

FIGS. 2A and 2B are views showing an example of an effect to be applied to a still picture. As seen in FIG. 2A, a frame image 3 after the effect is applied to the still picture is formed from a still picture 4 and other effect images.

In FIG. 2A, the still picture 4 is provided by the user such as a photograph image picked up by a digital camera. As shown in FIG. 2A, the image size of the still picture 4 is smaller than that of the frame image 3. Further, by successively displaying a plurality of frame images 3 as moving pictures, the still picture 4 apparently moves in a widthwise direction from the left to the right as indicated by an arrow mark 5 in the frame image 3.

Further, in the frame image 3, together with the still picture 4, a circular object 6 and rectangular objects 8, 10 and 12 are displayed as effects. By successively displaying a plurality of frame images 3 as moving pictures, the circular object 6 apparently moves in a vertical direction from an upper portion to a lower portion as indicated by an arrow mark 7 in the frame image 3. The rectangular objects 8, 10 and 12 are positioned adjacent each other, and apparently move, by successively displaying the plural frame images 3 as moving pictures, in a widthwise direction from the right to the left as indicated by arrow marks 9, 11 and 13, respectively, in the frame image 3.

Such a representation for one or several still pictures 4 as described above is hereinafter referred to as effect. Normally, an effect is a representation for displaying a set of still pictures for a period of time of several seconds. For example, the display size, shape and movement of the still picture 4 and the size, shape, movement and color of an object to be displayed together with the still picture 4 are different among different effects. Normally, a slideshow is a content for approximately several minutes formed from a plurality of effects.

In this manner, by displaying a group of still pictures while they are represented as a slideshow, the information processing apparatus 1 can enhance the amusement property of the group of still pictures and the degree of satisfaction of the user who enjoys the slideshow.

It is to be noted that the still picture 4 shown in FIG. 2A may be a provided photographed image itself which is not processed or a reduced image of the photographed image or else such a partial image L of the photographed image 14 as shown in FIG. 2B.

In this manner, a content (hereinafter referred to suitably as slideshow content) which implements a slideshow with BGM for automatically and successively displaying still pictures to which various effects are applied while a selected tune is played as BGM is produced by the user performing various selections in accordance with a wizard displayed on the TV2.

For example, the user can produce a slideshow content (actually a “play list” as hereinafter described) principally by two operations including an operation for selecting a photo album (a folder in which a still picture file is stored) in which still pictures to be reproduced by slideshow are stored and another operation for selecting a tune to be played as BGM.

In particular, in the information processing apparatus 1, for example, a predetermined number of tunes which can be utilized as BGM are stored in the built-in HDD, and effects for representing atmospheres matching with those of the tunes are coordinated with the tunes. The substance of each effect is set so as to match with the atmosphere of the tune depending upon, for example, the tempo, the genre or the like of the tune.

Accordingly, when a slideshow content is produced, only if the user selects a favorite tune to be played as BGM, then also an effect matching with an atmosphere of the selected tune can be selected.

Further, only if the user selects a photo album, then all of still pictures stored in the photo album can be selected as still pictures of a reproduction object without selecting the still pictures to be reproduced one by one. For example, where the reproduction time required when all of the still pictures stored in the photo album selected by the user are reproduced is different from that required to reproduce the tunes of BGM one time, the information processing apparatus 1 automatically performs an adjustment process and so forth for adjusting the number of still pictures to be used as a reproduction object such as sampling out, repetitive displaying or the like of the still pictures stored in the photo album so that the reproduction time of the still pictures and the reproduction time of the tunes are substantially equal to each other.

Consequently, only it is necessary for the user to merely select a photo album in which still pictures to be reproduced are stored without being conscious of the number of still pictures stored in one photo album, the reproduction time of a tune of BGM and so forth.

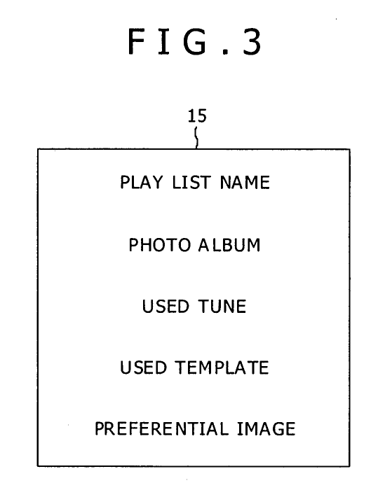

In response to such selection of the user as described above (selection of a photo album and a tune of BGM), the information processing apparatus 1 produces such a play list 15 as shown in FIG. 3.

When the user selects a certain play list 15, a photo album and a tune of BGM which are objects of the play list 15 are read out, and still pictures stored in the photo album are reproduced in accordance with a reproduction procedure defined by the play list 15. At this time, also the read out tune is reproduced as BGM. In this manner, the play list 15 is information which defines a reproduction procedure of still pictures for producing a slideshow content.

Here, the substance of description of the play list 15 is described.

Referring to FIG. 3, for example, “play list name”, “photo album”, “used tune”, “used template” and “preferential image” are described in the play list 15.

The “play list name” is a title of the play list 15 and is set by the user as occasion demands.

The “photo album” is information which designates a photo album into which still pictures of an object of reproduction are to be stored. When a play list 15 is selected by the user, a photo album designated by the “photo album” of the selected play list 15 is read out from the HDD, and the still pictures stored in the photo album are reproduced (displayed).

The “used tune” is information which designates a tune of BGM. When a play list 15 is selected by the user, a tune designated by the “used tune” of the selected play list is read out from the HDD and reproduced as BGM.

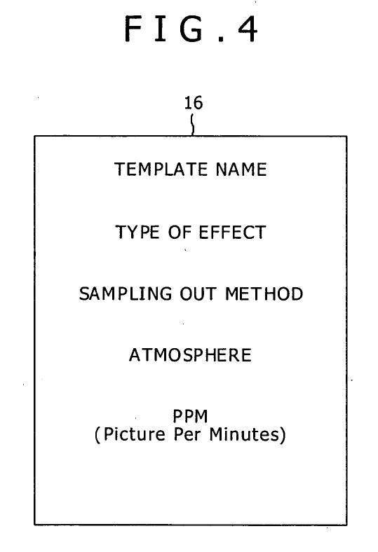

The “used template” is coordinated with a tune designated by the “used tune” and is information which designates a template in which the substance of an effect and so forth are described (for example, “template name” of FIG. 4). When a play list 15 is selected by the user, a template designated by the “used template” of the selected play list 15 is read out from the HDD, and an effect of the substance described in the template is applied to the still pictures of a reproduction object. The template is hereinafter described with reference to FIG. 4.

The “preferential image” is information which designates a still picture to be displayed preferentially from among still pictures stored in a photo album designated by the “photo album”. Where a great number of still pictures are stored in a photo album, some of them are occasionally sampled out in accordance with the reproduction time of the tune of BGM as described hereinabove. However, a still picture designated by the “preferential image” is not made an object of the sampling out but is selected as a still picture of an object of reproduction preferentially to the other still pictures. The designation of the “preferential picture” may be performed automatically by the information processing apparatus 1 or may be designated by the user itself.

FIG. 4 shows an example of description of a template.

Referring to FIG. 4, for example, “template name”, “type of effect”, “sampling out method, “atmosphere” and “PPM (Picture Per Minutes)” are described in the template 16.

The “template name” is the title of the template 16.

The “type of effect” is information which designates candidates for a type (substance) of an effect to be applied to still pictures of an object of reproduction. A plurality of sub effects are prepared in advance which represent, for example, which part of one still picture should be displayed, which part of the entire screen should be displayed, what size should be used for the display, and in what direction a movement should be performed, and the substance of one effect is determined by a combination of sub effects in accordance with the tempo and so forth of a tune with which the template 16 is coordinated. The combination of sub effects or the like is designated by the “type of effect” of the template 16. In other words, the “type of effect” is a list of candidates for the effect to be utilized when slideshow is performed in accordance with the template 16, and usually, a plurality of candidates are listed up. Then, an arbitrary one of the effects included in the list is utilized for the slideshow.

The “sampling out method” is information which designates a method to be used to sample out still pictures stored in a photo album. The “sampling out method” is actually used to adjust the reproduction time of the still pictures and the reproduction time of a tune of BGM so as to be substantially equal to each other. It is to be noted that the information processing apparatus 1 may be configured otherwise such that the user can set on/off of the sampling out of still pictures. When the sampling out of still pictures is off (when sampling out is not performed), all of the still pictures stored in a photo album designated by the “photo album” of the play list 15 are determined as still pictures of an object of reproduction.

The “atmosphere” is information representative of an atmosphere represented where still pictures are reproduced in accordance with the template 16.

The “PPM” is information which designates the number of still pictures to be reproduced (displayed) for one minute. The information processing apparatus 1 reproduces each of still pictures of an object of reproduction for a period of time designated by the “PPM”.

The information processing apparatus 1 having such a configuration as described above performs a process of providing image data of still pictures to be displayed to a slideshow application therefore in accordance with a process executed by the slideshow application such as reproduction of still pictures in which the play list 15 and the template 16 are used. In particular, the information processing apparatus 1 performs such processes as reading out and decoding of image data using a memory separately from a process executed by a slideshow application so that the slideshow application can successively display still pictures continuously in a stable state without a delay at output timings scheduled in advance.

Details of such processes as described above are hereinafter described with reference to flow charts.

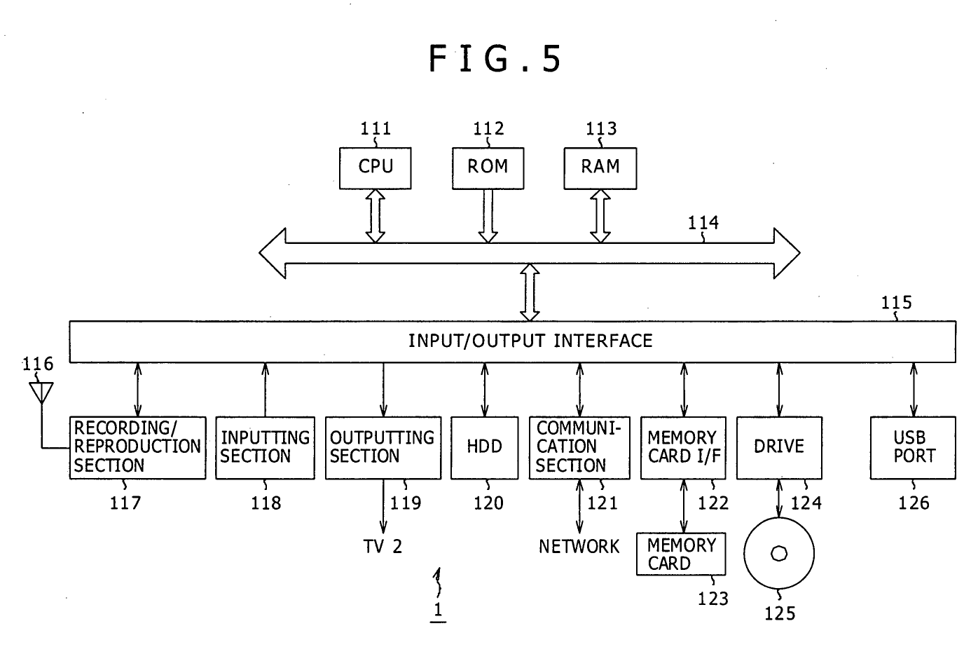

FIG. 5 shows an example of a configuration of the information processing apparatus 1 of FIG. 1.

Referring to FIG. 5, a CPU (Central Processing Unit) 111 executes various processes in accordance with a program stored in a ROM (Read Only Memory) 112 or a program loaded from a HDD (Hard Disk Drive) 120 into a RAM (Random Access Memory) 113. Also data necessary for the CPU 111 to execute the processes are suitably stored into the RAM 113.

The CPU 111, ROM 112 and RAM 113 are connected to one another by a bus 114. Also an input/output interface 115 is connected to the bus 114.

A recording/reproduction section 117, an inputting section 118, an outputting section 119, a HDD 120, a communication section 121, a memory card I/F (InterFace) 122, a drive 124 and a USB port 126 are connected to an input/output interface 115.

The recording/reproduction section 117 compresses television program data acquired from a signal supplied thereto from an antenna 116 in accordance with, for example, the MPEG (Moving Picture Experts Group) 2 method and supplies the data (video content) obtained by the compression to the HDD 120 through the input/output interface 115 so as to be stored into the HDD 120. Further, the recording/reproduction section 117 decompresses a video content stored in the HDD 120 and outputs resulting image data of a television program from the outputting section 119 to the TV2. In short, the information processing apparatus 1 has a function of recording and reproducing a television program.

The inputting section 118 is formed from, for example, a reception element of infrared rays. The inputting section 118 receives a signal from a remote controller not shown and outputs information representative of the substance of an operation of a user to the-CPU 111.

The outputting section 119 converts image data supplied thereto through the input/output interface 115 into an analog signal and outputs a resulting image signal to the TV2 through a cable. To the outputting section 119, for example, image data obtained by reproduction of a still picture in accordance with a play list, image data of a video content reproduced by the recording/reproduction section 117 or like data are supplied. Further, the outputting section 119 converts tune data supplied thereto through the input/output interface 115 into an analog signal and outputs the resulting signal to the TV2.

The HDD 120 stores a video content obtained by the recording/reproduction section 117, a still picture fetched from a memory card 123 through the memory card I/F 122, a still picture fetched from a digital camera through the USB port 126 and a USB cable and tune data (audio content) fetched from an optical disk 125 by the drive 124 and compressed in accordance with the MP3 (MPEG Audio Layer-3) method or the like.

The HDD 120 further stores play lists produced through selection by the user, data of tunes of BGM, templates coordinated with the tunes of BGM, slideshow contents and so forth.

The communication section 121 performs a communication process through a network.

The memory card I/F 122 reads out data stored in the memory card 123 loaded in a memory card slot formed in a housing of the information processing apparatus 1 and stores the read out data into the HDD 120 or the like. For example, data of a still picture are fetched into the information processing apparatus 1 through the memory card 123.

The drive 124 drives the optical disk 125 loaded therein to perform reading out of data stored on the optical disk 125 and writing of data on the optical disk 125. The optical disk 125 is a CD (Compact Disk), a DVD (Digital Versatile Disk) or the like, and data of a still picture, an audio content, a video content or the like are fetched into the information processing apparatus 1 from the optical disk 125. Further, the drive 124 suitably writes a produced slideshow content on the optical disk 125.

It is to be noted that the information processing apparatus 1 has a function also as a game machine. Also an image of a game (program) read out from the optical disk 125 by the drive 124 is supplied to the outputting section 119 through the input/output interface 115 and outputted to the TV2.

The USB port 126 performs communication with an external apparatus such as a digital camera through the USB cable to store a fetched still picture (image data) into the HDD 120.

FIG. 6 shows a functional configuration of the information processing apparatus 1. At least some of the various functional sections shown in FIG. 6 are implemented by a predetermined program executed by the CPU 111 of FIG. 5.

The information processing apparatus 1 includes a content management section 131, a BGM/template management section 132, a slideshow content production section 133, a reproduction section 134, a play list production section 135 and a output control section 136.

The content management section 131 manages various contents such as still pictures, video contents, audio contents and play lists stored in the HDD 120. Information of the contents managed by the content management section 131 is outputted to the output control section 136 and used for display of a menu screen hereinafter described.

The content management section 131 supplies, upon production of a play list, information of the title of a photo album selected by the user to the play list production section 135. Upon reproduction of a play list, the content management section 131 reads out a photo album which is a reproduction object of the play list (photo album designated by the “photo album” of the play list) from the HDD 120 and outputs the photo album to the reproduction section 134. Further, the content management section 131 stores a slideshow content produced by the slideshow content production section 133 and supplied thereto into the HDD 120.

The BGM/template management section 132 manages the tunes of BGM and the templates in a coordinated relationship with each other and stores them into the HDD 120. Upon production of a play list, the BGM/template management section 132 outputs information of the tunes of BGM managed thereby to the output control section 136 and outputs the information of a tune of BGM selected by the user and a template coordinated with the tune to the play list production section 135. On the other hand, upon reproduction of a play list, the BGM/template management section 132 outputs a template designated by the “used template” of the play list and a tune of BGM designated by the “used tune” to the reproduction section 134.

The slideshow content production section 133 acquires output vector data equivalent to a reproduction result of the reproduction section 134 (an array of a plurality of still pictures reproduced successively in accordance with a play list) from the reproduction section 134 and adds information necessary for a title and so forth to the output vector data to produce a slideshow content completed as a content. The slideshow content produced by the slideshow content production section 133 is outputted to the content management section 131 and stored into the HDD 120.

When an instruction to reproduce a play list is issued, the reproduction section 134 acquires the play list which is an object of the reproduction instruction issued, a photo album of the play list designated by the “photo album” and a tune of BGM designated by the “used tune” to perform reproduction of the play list. Further, the reproduction section 134 supplies output vector data equivalent to output data in accordance with a request from the slideshow content production section 133 to the slideshow content production section 133. A detailed configuration of the reproduction section 134 is described below with reference to FIG. 7.

The play list production section 135 produces such a play list as shown in FIG. 3 which describes information of a photo album selected by the user, information of a tune of BGM selected by the user, information of a template coordinated with the tune and so forth and outputs the produced play list to the content management section 131 or the reproduction section 134. Information of the photo album selected by the user during production of a play list is received from the content management section 131, and the information of the tune of BGM and the information of the template coordinated with the tune are received from the BGM/template management section 132.

The output control section 136 produces a screen (wizard screen) for guiding a production procedure of a play list to the user or a menu screen to be used as a start screen for operations to be executed using the information processing apparatus 1 based on information supplied thereto from the content management section 131, BGM/template management section 132 and reproduction section 134 and controls the TV2 to display the wizard screen or the menu screen.

FIG. 7 shows an example of a detailed configuration of the reproduction section 134.

Referring to FIG. 7, the reproduction section 134 includes a play list reproduction control section 141, an output vector data production section 142, a slideshow content reproduction control section 143, a BGM reproduction section 144, an extraction section 145, an effect image processing section 146, an internal memory 147, a buffer management section 148 and a decoding processing section 149.

When a play list whose reproduction instruction is issued by the user is received from the content management section 131, the play list reproduction control section 141 analyzes the play list and supplies information necessary for production of output vector data to the output vector data production section 142.

The output vector data production section 142 produces output vector data, which are data of the vector format of a slideshow file to be outputted, based on the information supplied thereto from the play list reproduction control section 141 (information of the play list, a template and so forth). The information of an effect or the like is formed as information of the vector format wherein it is represented as a set of parameters of equations of coordinates of points or lines or planes which interconnect the points, plotting information such as painting up, a special effect or the like. In particular, the output vector data production section 142 selects, from within information designated by the play list, BGM, a still picture, an effect and so forth to be adopted for a slideshow file and produces data (output vector data) of the vector format equivalent to the slideshow file to be outputted using the selected information. It is to be noted that the play list does not particularly designate still pictures to be displayed, an order in which the still pictures are to be displayed, or an effect to be applied to the still pictures. The output vector data production section 142 determines a particular substance of the slideshow file by producing such output vector data as described above. The output vector data production section 142 supplies the produced output vector data to the BGM reproduction section 144, extraction section 145, and effect image processing section 146.

When the slideshow content designated by the user, that is, output vector data, are received from the content management section 131, the slideshow content reproduction control section 143 supplies the slideshow content (output vector data) to the BGM reproduction section 144, extraction section 145 and effect image processing section 146 to control reproduction of the slideshow content. The slideshow content is a content completed as a slideshow file and is formed from data of the vector format. In other words, the slideshow content is the output vector data described above stored as a content.

The BGM reproduction section 144 acquires a tune of BGM from the BGM/template management section 132 based on the output vector data supplied thereto from the output vector data production section 142 or the slideshow content reproduction control section 143, reproduces the acquired tune data and supplies the reproduced tune data to the effect image processing section 146.

The extraction section 145 performs sampling out or the like of still pictures stored in a photo album supplied thereto from the content management section 131 in accordance with the output vector data supplied thereto from the output vector data production section 142 or the slideshow content reproduction control section 143 to extract still pictures of an object of reproduction. By the sampling out process, the reproduction time of still pictures is adjusted so as to be substantially equal to the reproduction time of the BGM. Each still picture extracted by the extraction section 145 is supplied as a still picture of an object of reproduction to the effect image processing section 146.

It is to be noted that, if the sampling out process is set inoperative, then the extraction section 145 does not perform the sampling out process of still pictures but supplies all still pictures stored in the photo album and supplied thereto from the content management section 131 as still pictures of an object of reproduction to the internal memory 147 so as to be stored into the internal memory 147.

The effect image processing section 146 acquires still pictures (still pictures of image data decoded as hereinafter described) supplied thereto from the output vector data production section 142 or the slideshow content reproduction control section 143, applies an effect to the still pictures, produces output data from the data of the still pictures (frame image data of the raster format), to which the effect is applied, in a synchronized relationship or the like with BGM data supplied thereto from the BGM reproduction section 144, and supplies the output data to the output control section 136. Further, the effect image processing section 146 supplies the used output vector data at a predetermined timing to the internal memory 147 so as to be stored into the internal memory 147.

The internal memory 147 is a memory area assured in the RAM 113 by a process executed by the CPU 111 of FIG. 5 and is utilized as a buffer memory for temporarily retaining still pictures (image data) of an object of reproduction, as a memory for temporarily storing the output vector data, and so forth. The output vector data are outputted to the slideshow content production section 133 as occasion demands. A particular configuration of the internal memory 147 is hereinafter described with reference to FIG. 8.

The buffer management section 148 performs a process relating to management of a buffer edited utilizing part of the storage area of the internal memory 147. For example, the buffer management section 148 constructs buffers based on setting information and so forth set in advance by a user input or the like and retained in the internal memory 147 in order to temporarily store still pictures (image data) of an object of reproduction. It is to be noted that the buffer management section 148 includes an image data management section 151 and a status management section 152.

Although a particular description is hereinafter given, a buffer constructed in the internal memory 147 is formed from image data of an object of reproduction and information representative of a status of the image data. The image data management section 151 manages image data retained in the buffer based on the value of the status corresponding to the image data. Further, the status management section 152 performs a process of managing the value of the status.

In particular, image data of a reproduction object retained in the internal memory 147 are supplied in accordance with a request from the effect image processing section 146 to the effect image processing section 146 through the control process by the buffer management section 148 (including the image data management section 151 and the status management section 152).

The decoding processing section 149 acquires image data retained in the buffer of the internal memory 147 (encoded image data supplied from the extraction section 145 and stored in the internal memory 147) and performs a decoding process for the acquired image data in accordance with a method corresponding to the encoding method. After the decoding process is completed, the decoding processing section 149 stores the decoded image data into the buffer of the internal memory 147 again.

Reproduction of a play list by the reproduction section 134 which has such a configuration as described above is performed also when an instruction to perform preview reproduction of the play list being produced is issued by the user. When an instruction to perform preview reproduction of the play list is issued, the play list being produced is supplied from the play list production section 135 to the reproduction section 134, and reproduction of the play list is performed by the components shown in FIG. 7.

FIG. 8 shows an example of a detailed configuration of the internal memory 147 of FIG. 7.

Referring to FIG. 8, the internal memory 147 retains setting information 161, buffers 162-1 to 162-5, output vector data and so forth.

The setting information 161 is setting information relating to the buffers constructed in the internal memory 147 and set in advance in accordance with a user input and so forth. The setting information 161 includes information of a buffer number 171 indicative of the number of buffers constructed in the internal memory 147, a cache number 172 representative of the number of still pictures after outputted which can be stored, and so forth. The buffer number 171 is setting information of the number of buffers constructed in the internal memory 147 (that is, a maximum number of still pictures to be stored at the same time), and the buffer management section 148 constructs a number of buffers equal to the value of the buffer number 171 in the internal memory 147. Further, the cache number 172 is setting information representative of a maximum number of used (outputted) image data (maximum number of still pictures) stored in the buffers constructed in such a manner as just described. The image data management section 151 and the status management section 152 of the buffer management section 148 perform management processes of image data and statuses based on the setting information.

The buffers 162-1 to 162-5 are buffers constructed in such a manner as described above. In particular, in the internal memory 147 shown in FIG. 8, the value of the buffer number 171 of the setting information 161 is set to “5”. Te buffer 162-1 includes image data 181-1 and status 182-1. The image data 181-1 is a region for storing one piece of image data of still pictures of a reproduction object (that is, one sill picture). The status 182-1 is a region for storing information (status) of the status of image data stored in the image data 181-1. The status of image data indicates one of six different statuses of “image decoding waiting”, “image decoding proceeding”, “image decoding completed”, “image in-use”, “cache” and “abandon”. The status 182-1 stores such a status of the image data 181-1 as just described. It is to be noted that the set maximum number of images whose status is “cache” is stored in the cache number 172. Transition between the statuses is hereinafter described.

Also the buffer 162-2 to the buffer 162-5 have a basically similar configuration to that of the buffer 162-1, and therefore, overlapping description of the configuration is omitted herein to avoid redundancy. It is to be noted that, where there is no necessity to identify the buffers 162-1 to 162-5 from one another, each of them is referred to simply as buffer 162. This similarly applies to the image data 181-1 to 181-5 and the statuses 182-1 to 182-5, and where there is no necessity to identify them from one another, each of them is referred to simply as image data 181 or status 182.

It is to be noted that also output vector data 163 are stored in the internal memory 147 as described hereinabove.

While, in the forgoing description, the number of buffers 162 constructed in the internal memory 147 is 5, the number of buffers 162 is not limited to this, but may be any number if this is set to the buffer number 171. Further, while it is described above that the statuses 182 are stored in the buffers 162 in FIG. 8, this represents that they individually correspond to the (image data stored in the) buffers (that is, represents relationships between the statuses 182 and the buffers), and naturally the statuses 182 may not physically be stored in the buffers 162 even if such relationships are maintained. In other words, the statuses of the image data 181 stored in the buffers 162 may be managed anywhere, and, for example, all of the statuses 182 may be managed collectively as table information.

Now, a process executed by the buffer management section 148 of FIG. 7 is described. The buffer management section 148 (and the image data management section 151 and the status management section 152) executes such processes as hereinafter described to supply (image data of) still pictures of a reproduction object stored in the internal memory 147 to the slide application side, that is, to the effect image processing section 146 which performs a process based on output vector data.

Consequently, the information processing apparatus 1 can successively output a plurality of data continuously in a stable state without a delay at output timings scheduled in advance without increasing the cost.

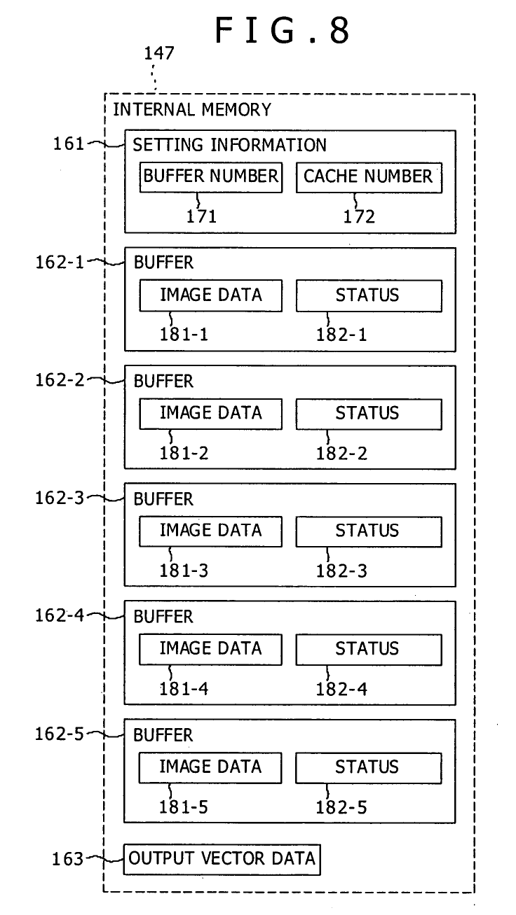

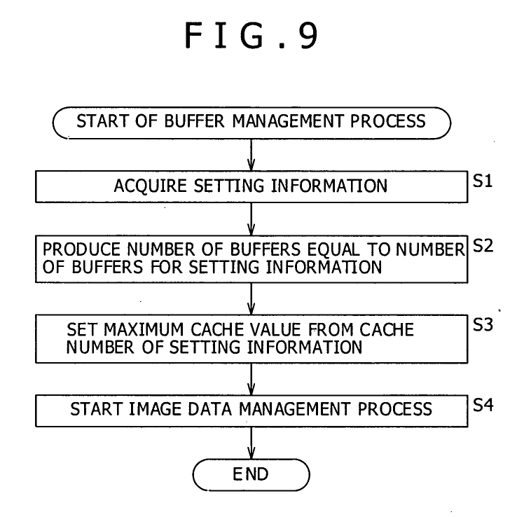

First, a buffer management process by the buffer management section 148 is described with reference to a flow chart of FIG. 9.

After the buffer management process is started, the buffer management section 148 acquires the setting information 161 stored in the internal memory 147 at step S1. After the setting information 161 is acquired, the buffer management section 148 produces or constructs a number of buffers 162 equal to the value of the buffer number 171 included in the setting information 161 in a storage area of the internal memory 147 at step S2. After the buffers 162 are constructed, the processing advances to step S3, at which the buffer management section 148 sets a maximum cache value (limit value to the number of image data whose status is “cache”) based on the value of the cache number 172 included in the buffer 162. Then, the buffer management section 148 advances the processing to step S4, at which it controls the image data management section 151 to start an image data management process as a different task, and then ends the buffer management process.

As described above, the buffer management section 148 executes the buffer management process as a process different from a process of outputting a slideshow file, constructs the buffers 162 in the internal memory 147 based on the setting information 161 set in advance and controls the image data management section 151 to execute the image data management process in which the buffers 162 are used. Therefore, the buffer management section 148 can control the internal memory 147 to successively supply still pictures in a stable state without a delay at output timings scheduled in advance to the effect image processing section 146 which performs a process relating to outputting of a slideshow file.

Further, since the buffer management section 148 reduces the load of a decoding process by efficiently utilizing the buffers 162 as hereinafter described, the information processing apparatus 1 can suppress increase of the fabrication cost and the service cost of the decoding processing section 149. Further, the area size of the internal memory 147 to be assured as the buffers 162 by the buffer management section 148 can be reduced, and the information processing apparatus 1 can suppress increase of the fabrication cost and the service cost of the internal memory 147.

Accordingly, a plurality of data can be successively outputted in a stable state without any delay at output timings scheduled in advance without increasing the cost.

Now an image data management process by the image data management section 151 is described with reference to a flow chart of FIG. 10.

After the image data management process is started, the image data management section 151 decides, at step S11, whether or not a buffer whose status is “abandon” (a “free” buffer in which no image data is stored) exists. If it is decided that such a buffer as just mentioned exists, then the processing advances to step S12, at which the image data management section 151 causes the internal memory 147 to acquire image data supplied from the extraction section 145, and then to step S13, at which the image data are stored into the buffer 162 whose status is “abandon”. Then at step S14, the image data management section 151 controls the status management section 152, in which the image data are stored, to start the status management process in which the image data is retained as a different task. The status management process is hereinafter described.

After the process at step S14 is completed, the image data management section 151 advances the processing to step S15. On the other hand, if it is decided at step S11 that a buffer 162 whose status is “abandon” does not exist (in other words, image data are stored in all of the buffers 162), then the image data management section 151 omits the processes at steps S12 to S14 and advances the processing directly to step S15.

At step S15, the image data management section 151 refers to the status 182 of each of the buffers 162 to decide whether or not a buffer 162 whose status is “image decoding proceeding” and which is not processed as yet exists. In particular, the image data management section 151 decides whether or not there exist image data whose decoding turn comes round. If such image data exists, then the processing advances to step S16, at which the image data management section 151 causes the image data to be supplied to the decoding processing section 149 so that the decoding processing section 149 starts a decoding process of the image data.

After the decoding process is started, the image data management section 151 advances the processing to step S17. On the other hand, if it is decided at step S15 that a buffer 162 whose status is “image decoding proceeding” and which is not processed as yet does not exist, then the image data management section 151 omits the process at step S16 and advances the processing to step S17.

At step S17, the image data management section-151 decides whether or not a request for image data to the internal memory 147 is issued from the effect image processing section 146. If it is decided that a request for image data is issued, then the image data management section 151 advances the processing to step S18. At step S18, the image data management section 151 supplies the image data whose status is “image decoding completed” to the effect image processing section 146.

Then at step S19, the image data management section 151 decides whether or not a requested number of image data are supplied to the effect image processing section 146. If the image data management section 151 decides that the number of image data whose status is “image decoding completed” is insufficient and the requested number of image data are not supplied, then the processing is advanced to step S20. At step S20, the image data management section 151 supplies image data whose status is “cache”, that is, a still picture outputted once, again.

At step S21, the image data management section 151 decides whether or not the requested number of image data is supplied to the effect image processing section 146. If the image data management section 151 decides that the number of image data whose status is “image decoding completed” is insufficient and the registered number of image data are not supplied to the effect image processing section 146, then the image data management section 151 returns the processing to step S18 so that the processes at the steps beginning with step S18 are repeated.

If the image data management section 151 decides at step S21 that the requested number of image data is supplied to the effect image processing section 146, then it advances the processing to step S22. Further, if the image data management section 151 decides at step S19 that the requested number of image data is supplied to the effect image processing section 146, then it advances the processing to step S22. Furthermore, if the image data management section 151 decides at step S17 that a request for image data is not issued, then it advances the processing to step S22.

At step S22, the image data management section 151 decides whether or not the image data management process should be ended. If it is decided that the image data management process should not be ended, then the image data management section 151 returns the processing to step S11 to repeat the processes at the steps beginning with step S11. On the other hand, if it is decided at step S22 that the image data management process should be ended, then the image data management section 151 advances the processing to step S23, at which an ending process is performed, whereafter the image data management process is ended.

As described above, since, every time the image data management section 151 stores image data into a buffer 162, it causes the status management section 152 to start the status management process and manage the status of the image data, the image data management section 151 can appropriately manage inputting/outputting and so forth of the image data based on the status.

For example, the image data management section 151 can store new image data into a buffer 162 whose status has changed to “abandon” by executing the processes at steps S11 and S14. Consequently, the utilization efficiency of the buffers 162 can be enhanced.

Further, since, for example, the image data management section 151 can supply imaged data whose status has changed to “image decoding proceeding” and which is not decoded as yet to the decoding processing section 149 by executing the processes at steps S15 and S16, image data can be supplied at an appropriate timing to the decoding processing section 149. Consequently, the decoding processing section 149 can operate stably. In particular, since the image data management section 151 can suppress increase/decrease of the load of the decoding process to enhance the utilization efficiency of the decoding processing section 149 and suppress appearance of standby time or the like, stabilized supply of image data to the effect image processing section 146 can be implemented. Consequently, the information processing apparatus 1 can successively apply a plurality of data in a stable state without a delay at output timings scheduled in advance without increasing the cost.

Further, when the number of image data whose status is “image decoding completed” is insufficient with respect to a request from the effect image processing section 146, that is, when the decoding process by the decoding processing section 149 delays with respect to the progress of the slideshow, the image data management section 151 successively supplies image data which have been outputted formerly and whose status is “cache” to the effect image processing section 146 again by executing the processes at steps S17 to S21. Consequently, the image data management section 151 can supply a number image data equal to the request number to the effect image processing section 146 stably. As a result, the information processing apparatus 1 can successively output a plurality of data continuously in a stable state without a delay at output timings scheduled in advance without increasing the cost.

As described above, the image data management section 151 can supply image data supplied thereto from the extraction section 145 stably to the effect image processing section 146 at an arbitrary timing. Further, at this time, since the image data management section 151 can enhance the utilization efficiency of the buffers 162 or the decoding processing section 149 by managing image data stored in the buffers 162 in accordance with the status, increase of the fabrication cost and the service cost can be suppressed. Furthermore, since the image data management section 151 performs management of image data supplied thereto from the extraction section 145 based on the status of the image data until the image data are supplied to the effect image processing section 146, for example, the necessity to confirm whether or not the decoding processing section 149 ends the decoding process or perform address management of image data as occasion demands is eliminated. Consequently, complication of the management process can be suppressed and management of image data can be performed easily.

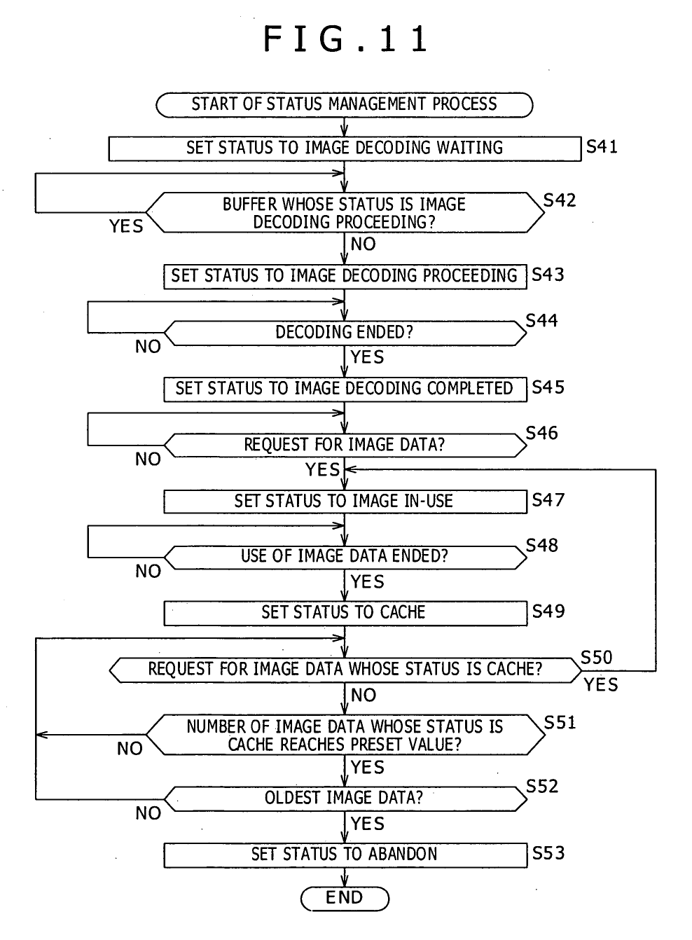

Now, the status management process by the status management section 152 is described with reference to a flow chart of FIG. 11.

Since the status management process is started immediately after image data are stored into a buffer (at step S14 of FIG. 10) as described hereinabove, the status management section 152 sets the status of (the image data stored in) the buffer to “image decoding waiting” at step S41. The status “image decoding waiting” represents a state wherein the image data waits that the turn of the decoding process by the decoding processing section 149 comes round. The status of the image data stored in the buffer 162 is first set to “image decoding waiting”, and the image data waits coming round of the turn of the decoding process by the decoding processing section 149.

At step S42, the status management section 152 decides whether or not a buffer whose status is “image decoding proceeding” exists. The status “image decoding proceeding” represents that the image data are being decoded by the decoding processing section 149 (the turn of the decoding process has come round). In other words, that a buffer whose status is “image decoding proceeding” does not exist indicates that the decoding processing section 149 is not operating (that is, is an inoperative state wherein it is not performing the decoding process).

Accordingly, if it is decided that a buffer whose status is “image decoding proceeding” does not exist, then the status management section 152 advances the processing to step S43, at which it changes the status of one of those buffers 162 whose status is “image decoding waiting” to “image decoding proceeding” so that a buffer of “image decoding proceeding” normally exists (the decoding processing section 149 normally performs the decoding process). After the process at step S43 is completed, the status management section 152 advances the processing to step S44.

It is to be noted that, if it is decided at step S42 that a buffer whose status is “image decoding proceeding” exists, then the status management section 152 stands by while it repeats the process at step S42 until it is decided by the status management section 152 that a buffer 162 whose status is “image decoding proceeding” does not exist.

At step S44, the status management section 152 decides whether or not the decoding process by the decoding processing section 149 is ended, and the status management section 152 stands by until it is decided that the decoding process is ended. If it is decided that the decoding process is ended, then the status management section 152 advances the processing to step S45, at which it sets the status of the buffer (image data) to “image decoding completed”.

After the process at step S45 is ended, the status management section 152 advances the processing to step S46, at which it decides whether or not a request for image data is issued from the effect image processing section 146 and stands by while the process at step S46 is repeated until it is decided that a request for image data is issued. If it is decided at step S46 that a request for image data is issued from the effect image processing section 146, then the status management section 152 advances the processing to step S47, at which it sets the status of the buffer (image data) to “image in-use”.

At step S48, the status management section 152 decides whether or not the use of image data by the effect image processing section 146 is ended. If the status management section 152 decides that the use of data is ended, then it advances the processing to step S49, at which it sets (changes) the status of the data to “cache”.

At step S50, the status management section 152 decides whether or not a request for image data whose status is “cache” is issued. If the status management section 152 decides that a request for image data is issued, then it returns the processing to step S47 so that the processes at the steps beginning with step S47 are repeated.

On the other hand, if the status management section 152 decides at step S50 that a request for image data whose status is “cache” is not issued, then it advances the processing to step S51, at which it decides whether or not the number of image data whose status is “cache” at present reaches the maximum cache value set at step S3 of FIG. 9. If the status management section 152 decides that the number of image data whose status is “cache” at present does not reach the maximum cache value, then it returns the processing to step S50 so that the processes at the steps beginning with step S50 are repeated.

On the other hand, if it is decided at step S51 that the number of image data whose status is “cache” at present reaches the maximum cache value, then the status management section 152 advances the processing to step S52, at which it decides whether or not the image data of the buffer are the oldest image data. If it is decided that the image data are not the oldest image data, then the status management section 152 returns the processing to step S50 so that the processes at the steps beginning with step S50 are repeated. On the other hand, if it is decided that the image data are the oldest image data, then the status management section 152 advances the processing to step S53, at which it sets (changes) the status of the image data to “abandon”. After the status is changed to “abandon”, the status management section 152 ends the status management process.

In this manner, the status management section 152 manages the status of image data stored in each of the buffers 162 and successively changes the status of the image data in order of “image decoding waiting”, “image decoding proceeding”, “image decoding completed”, “image in-use”, “cache” and “abandon” in response to the situation. Further, if image data whose status is “cache” are supplied to the effect image processing section 146, then the status management section 152 returns the status to “image in-use”.

In this manner, the status management section 152 successively changes the statuses of image data stored successively in the buffers in such an order as described above. Consequently, the image data management section 151 can utilize the internal memory 147 or the decoding processing section 149 effectively and supply the image data stably to the effect image processing section 146. Consequently, the information processing apparatus 1 can successively output a plurality of data continuously in a stable state without a delay at output timings scheduled in advance without unnecessarily increasing the cost.

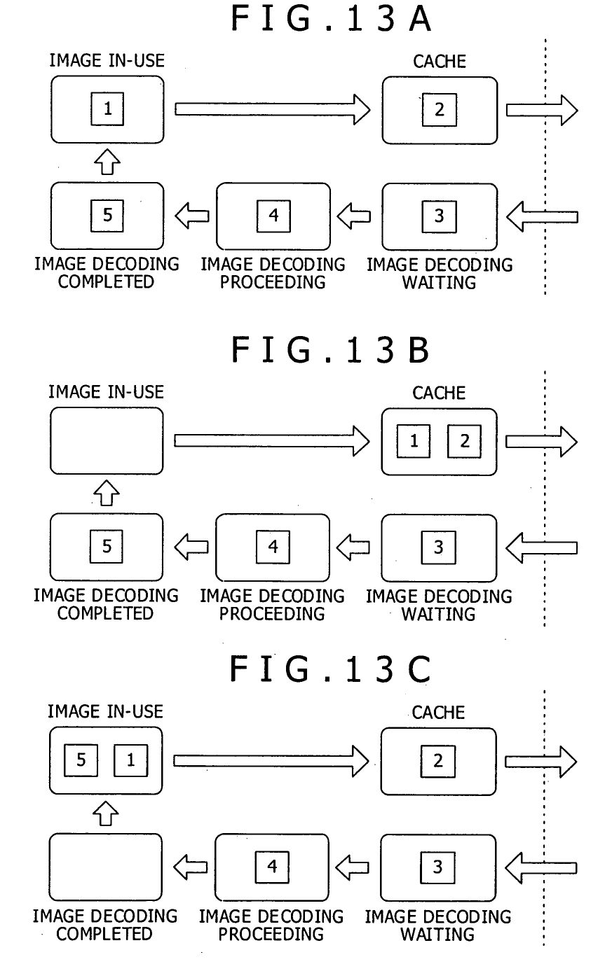

A particular example of the transition of the status is described. FIGS. 12 and 13 illustrate an example of transition of the status where the value of the buffer number 171 is “5” and the value of the cache number 172 is “2”. Each rectangular shape having rounded corners indicates a buffer 162 in every state while each square indicates image data stored in the buffer, and each arrow mark indicates a changing direction of the status. Further, the number of image data indicates identification information of a buffer in which the image data is stored. The identification information is used for description and actually may not be included in an actual image and may have any value. Further, if each buffer can be identified by some other method, then the identification information may not be used. Furthermore, while, in FIGS. 12 and 13, a state change of a buffer is indicated by the position of the same, actually only the status changes, but the address (region) of the buffer does not change.

It is assumed that, at a certain point of time, the buffers 162 have such states as seen in FIG. 12A. In particular, the status of (image data stored in) the buffer whose number is “1” is “image in-use”; the status of the buffers whose number is “2” and “3” is “cache”; the status of the buffer whose number is “4” is “image decoding waiting”; and the status of the buffer whose number is “5” is “image decoding proceeding”. In this state, if a request for two images is issued by the effect image processing section 146, then the status of the buffers changes to such a state as seen in FIG. 12B.

In particular, in FIG. 12B, the status of the buffer of the number “1” released in order to request for a next image changes to “cache”. This will result in increase of the total number of those buffers (image data) whose status is “cache” to 3, which is greater than the maximum cache number. Therefore, the status of the buffer (image data) which has the oldest number “3” is changed to “abandon” and the image data of the buffer is abandoned (or the protection condition of the image data or the buffer is canceled). Accordingly, the buffers whose number is “1” and “2” now have the status “cache”, different from those of FIG. 12A. At this time, the decoding process for the image data of the buffer of the number “5” is not ended as yet, and the status of the buffer remains “image decoding proceeding” similarly as in FIG. 12A. Accordingly, also the status of the buffer of the number “4” remains “image decoding waiting”.

Then, if a request for two images is issued by the effect image processing section 146, then the statuses of the buffers change to such a state as seen in FIG. 12C.

In particular, since, in the state of FIG. 12B, none of the image data has the status “image decoding completed”, the image data management section 151 supplies the image data of the buffers of the numbers “1” and “2” whose status is “cache”. The status management section 152 returns the statuses of the image data to “image in-use”. In other words, in this instance, the images displayed once are utilized again.

It is to be noted that, at this time, a new image is stored into the buffer of the number “3” whose status has been changed to “abandon” in FIG. 12B, and the status of the buffer is changed to “image decoding waiting”.

Further, it is assumed that, at a certain point of time, the buffers 162 are in such a state as shown in FIG. 13A. In particular, the status of (image data stored in) the buffer whose number is “1” is “image in-use”; the status of the buffer whose number is “2” is “cache”; the status of the buffer whose number is “3” is “image decoding waiting”; the status of the buffer whose number is “4” is “image decoding proceeding”; and the status of the buffer whose number is “5” is “image decoding completed”. In this state, if a request for two images is issued by the effect image processing section 146, then the status of the buffers changes to such a state as seen in FIG. 13B.

In particular, in FIG. 13B, the status of the buffer of the number “1” which is released in order to request for a next image changes to “cache”. At this time, two buffers including the buffer of the number “1” and the buffer of the number “2” have the status “cache”, and the total number of such buffers does not exceed the maximum cache number. Therefore, the statuses of the buffers are left as they are.

Then, if a request for two images is issued by the effect image processing section 146, then the statuses of the buffers change to such a state as seen in FIG. 13C.

In particular, since, in the state of FIG. 13B, only one buffer, that is, the buffer of the buffer number “5”, has the status “image decoding completed”, and the number of free buffers is insufficient to satisfy the request. Therefore, the image data management section 151 supplies the image data of the buffer of the number “1” whose status is “cache” together with the image data stored in the buffer of the number “5”. Then, the status management section 152 changes the status of the buffer of the number “1” back to “image in-use”. In other words, in this instance, the image displayed once is utilized again. It is to be noted that the statuses of the buffers of the number “2” to the number “4” do not change.

By managing the status of the buffers in which image data are stored and successively changing the statuses as seen in FGIS. 12A to 12C and 13A to 13C, the information processing apparatus 1 can successively output a plurality of data continuously in a stable state without a delay at output timings scheduled in advance without increasing the cost.

In particular, a method wherein image data after a decoding process are used only once (an image is displayed) as in the related art is inferior in withstanding property, for example, against occurrence of a delay or the like in the decoding process. For example, where decoded image data are supplied to a process which proceeds on the real-time basis, delay of the decoding process is likely to cause also the provision of the image data to delay, and there is the possibility that processing at the supplying destination of the image data may be stopped by the delay. Particularly where image data are supplied to the slideshow wherein still pictures are successively displayed with an effect applied thereto, the image data are subject to complicated image processes after the decoding process. In such an instance, even a little delay in supply of the image data may possibly have a significant influence on the progress of the entire process of the slideshow, and even if the process does not end abnormally, it is difficult to allow the slideshow to operate normally because of miss of frames of moving pictures, repetitions of temporary stop or the like. Therefore, it is conventionally necessary to produce a series of data (raster data) for the slideshow including still pictures to which an effect is applied in advance and reproduce (display) the data.

In contrast to such a conventional method as just described, according to such a configuration of the present embodiment as described above, a plurality of data can be successively outputted continuously in a stable state without a delay at output timings scheduled in advance without increasing the cost. Consequently, the necessity to produce a series of data for the slideshow is eliminated.

It is to be noted that, while, in the foregoing description, the image data to be stored into the buffers are still pictures, the data are not limited to this but may be moving picture data or frame images of moving pictures. Further, the data may be other than image data such as sound data.

Now, an example of particular use of such a buffer (image data) management process as described above is described.

First, a menu screen displayed on the TV2 by the output control section 136 is described.

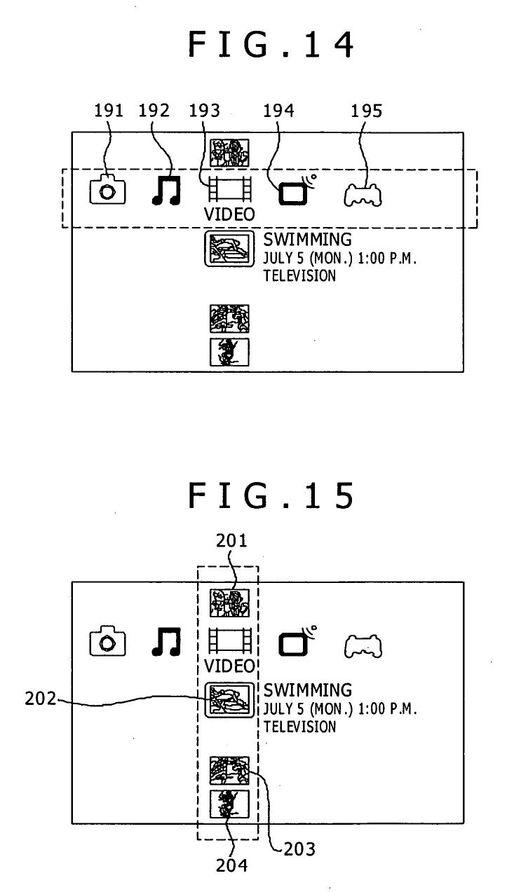

FIGS. 14 and 15 show an example of a menu screen.

On the menu screen, category icons 191 to 195 which individually represent different categories are displayed in an array in a horizontal direction of the screen and shown surrounded by a broken line in FIG. 14. Further, content icons (video content icons) 201 to 204 which represent contents belonging to that one of the categories which is selected by the user are displayed in an array in a vertical direction of the screen perpendicular to the array direction of the category icons 191 to 195 and shown surrounded by a broken line in FIG. 15. It is to be noted that the broken lines in FIGS. 14 and 15 are not actually displayed on the menu screen.

In the example of FIGS. 14 and 15, the category icon 191 representative of the category of “photo”, the category icon 192 representative of the category of “music”, the category icon 193 representative of the category of “video”, the category icon 194 representative of the category of “television” and the category icon 195 representative of the category of “game” are displayed in order in an array in the rightward direction from the left end of the screen.

Further, in the example of FIGS. 14 and 15, “video” is selected by the user, and the content icons 201 to 204 representative of video contents which belong to “video” are displayed in an array in a vertical direction. From among the content icons 201 to 204, the content icon 202 is currently selected, and a title and so forth of a video content represented by the content icon 202 is displayed alongside the content icon 202.

On such a menu screen as described above, the user can basically select a category by an operation in a horizontal direction (leftward or rightward button) of the remote controller and can select a content which belongs to the selected category by an operation in a vertical direction (upward or downward button).

In response to an operation by the user, the category icons 191 to 195 (category icons 191 to 195 and category icons representative of other categories which are not displayed in FIGS. 14 and 15) and the content icons 201 to 204 (content icons 201 to 204 and other content icons which are not displayed in FIGS. 14 and 15) are moved collectively as a whole and displayed.

For example, if the user depresses the leftward button only once in the state of FIG. 14 wherein “video” is selected, then the category icons 191 to 195 move as a whole in the rightward direction, and the category icon 192 is displayed at the position at which the category icon 193 is displayed in the state of FIGS. 14 and 15 and the category icon 191 is displayed at the position at which the category icon 192 is displayed in the state of FIGS. 14 and 15.

Similarly, the category icon 193 is displayed at the position at which the category icon 194 is displayed in the state of FIGS. 14 and 15, and the category icon 194 is displayed at the position at which the category icon 195 is displayed in the state of FIGS. 14 and 15. Furthermore, a category icon of a different category which is arrayed leftwardly of the category icon 191 and is not shown in FIGS. 14 and 15 is displayed at the position at which the category icon 191 is displayed in the state of FIGS. 14 and 15.

Consequently, “music” is selected in place of “video”, and content icons representative of audio contents which belong to “music” are displayed in an array in a vertical direction.

On the other hand, if the user depresses the leftward button only once in the state of FIG. 14, then the category icons 191 to 195 move as a whole in the rightward direction opposite to that where the leftward button is depressed, and “television” is selected.

Further, for example, if the user depresses the upward button only once in the state of FIG. 15 wherein the content icons 201 to 204 are displayed, then the content icons 201 to 204 move as a whole in the upward direction, and the content icon 202 is displayed at the position at which the content icon 201 is displayed in the state of FIGS. 14 and 15 and the content icon 203 is displayed at the position at which the content icon 202 is displayed in the state of FIGS. 14 and 15.

Similarly, the content icon 204 is displayed at the position at which the content icon 203 is displayed in the state of FIGS. 14 and 15, and a category icon which is disposed downwardly of the content icon 204 and is not shown in FIGS. 14 and 15 is displayed at the position at which the content icon 204 is displayed in the state of FIGS. 14 and 15.

Consequently, changeover from the state wherein the content icon 202 is selected to the state wherein the content icon 203 is selected occurs. At this time, a title and so forth of a video content represented by the content icon 203 are displayed alongside the content icon 203.

On the other hand, if the user depresses the downward button only once in the state of FIG. 14, then the content icons 201 to 204 entirely move in the downward direction opposite to that where the upward button is selected, and the content icon 201 is selected.,

By selecting a category and a content in such a manner as described above and then depressing a determination button of the remote controller, the user can cause a sub menu, on which operations which can be performed using the currently selected content are displayed in a list, to be displayed. The user can select, from within the sub menu displayed when a certain content is displayed, reproduction, copying, editing, deletion or the like of the currently selected content.

Now, a play list production process executed by the information processing apparatus 1 is described with reference to flow charts of FIGS. 16 to 18.

First, at step S71 of FIG. 16, the output control section 136 causes such a menu screen as described hereinabove with reference to FIGS. 14 and 15 to be displayed. If “photo” is selected on the menu screen, then an icon representative of a wizard which is used to produce or modify a play list is displayed alongside the content icon representative of the photo album.

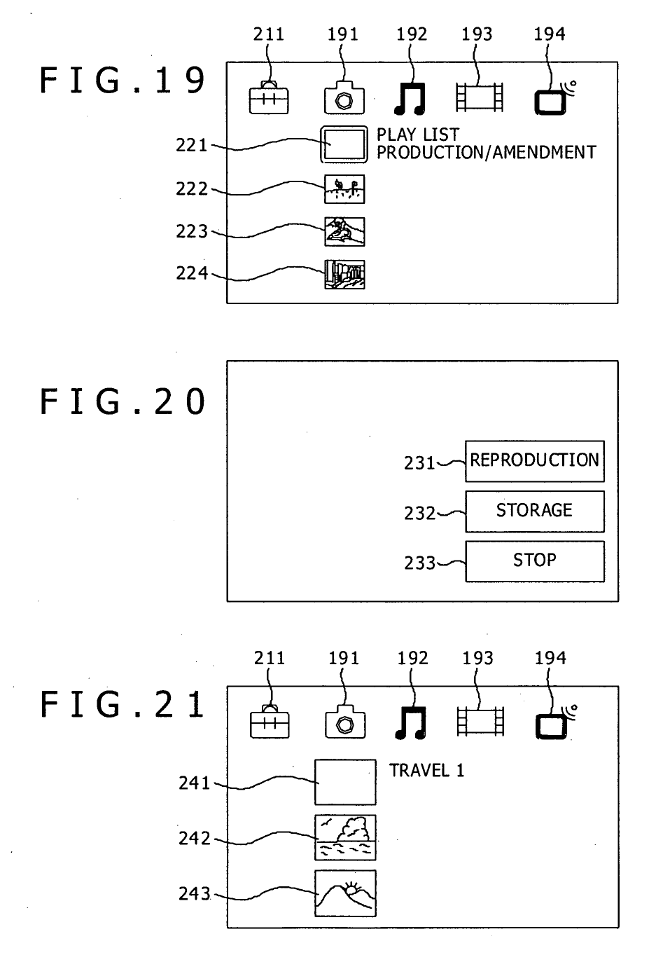

FIG. 19 shows an example of the menu screen displayed at step S71 of FIG. 16.

FIG. 19 shows the menu screen in a state wherein “photo” is selected. Referring to FIG. 19, an icon 221 representative of a wizard and content icons 222 to 224 representative of photo albums are displayed below the category icon 191. In FIG. 19, the icon 221 is selected, and characters of “production/amendment of play list” are displayed on the right side of the icon 221. It is to be noted that, in FIG. 19, a category icon 211 representative of a category of various settings is displayed on the left side of the category icon 191.

When the determination button is selected by the user in the state wherein the icon 221 is selected on the menu screen of FIG. 19 (when an instruction to activate the wizard is issued), the processing advances to step S72.

At step S72, the content management section 131 confirms the number of play lists produced already and stored in the HDD 120. Thereafter, the processing advances to step S73, at which the content management section 131 decides whether or not the number of play lists is equal to or smaller than a predetermined number. In particular, in the present example, an upper limit is set to the number of play lists, and where a number of play lists equal to the upper limit number are produced already, a play list cannot be produced any more.

If the content management section 131 decides at step S73 that the number of play lists is not smaller than the predetermined number (reaches the upper limit), then it notifies the output control section 136 of this. Thereafter, the processing advances to step S74.

At step S74, the output control section 136 causes a start screen, on which production of a new play list cannot be selected, to be displayed.

Although the start screen is not shown in the drawings, it includes, for example, a display of a message “A work may be produced from photographs stored in an album or a work produced already may be modified . . . ” and another display, below the first mentioned display, of characters “to be modified” which is selected when modification to a play list produced already is to be performed.

The user can perform, for example, modification to a play list produced already by depressing the determination button of the remote controller in the state wherein the characters of “to be modified” are selected (displayed in a reverse color). If the characters of “to be modified” are selected, then the play list production process illustrated in FIGS. 16 to 18 is ended, and a play list modification process is started. Description of the play list modification process is omitted herein.

On the other hand, if the content management section 131 decides at step S73 that the number of play lists is equal to or smaller than the predetermined number, then it notifies the output control section 136 of this. Thereafter, the processing advances to step S75.

At step S75, the output control section 136 causes another start screen, on which production of a new play list can be selected, to be displayed.

Although the start screen in this instance has a configuration basically similar to that of the start screen described hereinabove, for example, characters of “to be produced newly” are displayed above the characters of “to be modified”. When the determination button is depressed in a state wherein the characters of “to be produced newly” are selected by the user, the processing advances to step S76 to start a new play list production process.

At step S76, the content management section 131 decides whether or not a photo album is stored in the HDD 120. If it is decided that a photo album is not stored, then the content management section 131 notifies the output control section 136 of this. Thereafter, the processing advances to step S77.

At step S77, the output control section 36 causes an error screen, which notifies that there is no photo album, to be displayed.

On the error screen, for example, a message of “An album from which a play list can be produced is not found. The production/modification of a play list is ended.” is displayed. Since, in the information processing apparatus 1, selection of a still picture to be reproduced by the slideshow is performed by selection of a photo album as described hereinabove, when there is no photo album, the user cannot select a still picture of an object of reproduction. Thereafter, the processing returns to step S71 so that the processes at the steps beginning with step S71 are performed.

On the other hand, if it is decided at step S76 that a photo album is stored in the HDD 120, then the content management section 131 notifies the output control section 136 of this and outputs information of the photo album (title, image of an icon and so forth of the photo album) stored in the HDD 120 to the output control section 136. Thereafter, the processing advances to step S78.

At step S78, the output control section 136 causes a photo album selection screen to be displayed.

On the selection screen, for example, three icons representative of different photo albums are displayed. On the right side of the icons, for example, “album 2” which is a title of a photo album and “Jun. 2, 2004 1:00:32AM” which is the date and hour of the production (date and hour of fetching) are displayed. The user can select a desired one of the photo albums from within the selection screen.

When a photo album is selected, the content management section 131 confirms the format of still pictures stored in the selected photo album at step S79. Thereafter, the processing advances to step S80, at which the content management section 131 decides a still picture (JPEG file) which is compressed in accordance with the JPEG (Joint Photographic Expert Group) system is included in the photo album selected by the user. In other words, in the present example, a still picture of a processing object is a JPEG file.

If the content management section 131 decides at step S80 that no JPEG file is included in the photo album selected by the user, then it notifies the output control section 136 of this. Thereafter, the processing advances to step S81.

At step S81, the output control section 136 displays an error screen, which is for notification that no JPEG file is found, to be displayed.

On the error screen, for example, a message of “A file which can be utilized for production of a play list is not found. Please select another album.” is displayed. After this screen is displayed, the processing returns to step S78 so that selection of a photo album would be performed again.

On the other hand, if the content management section 131 decides at step S80 that a JPEG file is included in the photo album selected by the user, then it notifies the output control section 136 of this. Thereafter, the processing advances to step S82.

At step S82, the output control section 136 causes a selection screen for selection of a tune of BGM to be displayed. Information of the tune of BGM such as the title and an icon is supplied from the BGM/template management section 132.

On the selection screen, for example, three icons representative of different tunes are displayed, and the titles of the tunes are displayed on the right side of the icons. The user can select a desired tune from within the selection screen and use the tune as BGM upon slideshow. Since tunes of BGM and templates are coordinated with each other as described hereinabove, selection of a tune here signifies selection also of a template.

When a tune of BGM is selected, the output control section 136 causes, at step 83, a confirmation screen of the substance of the selections till then (setting relating to a play list to be produced) to be displayed.

On the confirmation screen, for example, “guide to travel” which is a title of a photo album selected by the user, “Music 1” which is a title of the tune of BGM selected by the user, “2:00” which is a period of reproduction time of “Music 1” and so forth are displayed. The user can confirm the substance of the setting and select whether or not a play list should be produced based on the setting”.

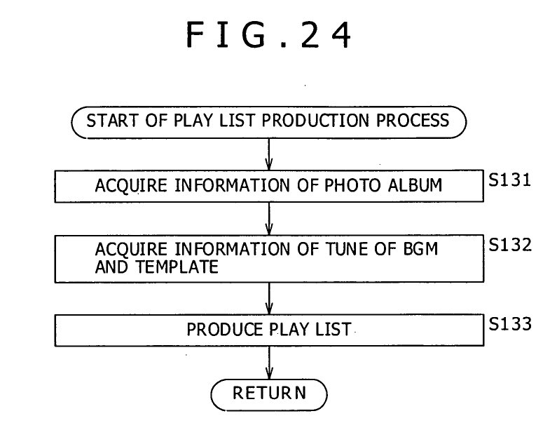

If an instruction to produce a play list is issued, then a play list production process is performed at step S84. Through the play list production process, such a play list as shown in FIG. 3 is produced in response to selection by the user by the play list production section 135. Details of the play list production process are hereinafter described with reference to a flow chart of FIG. 24. It is to be noted that the play list produced here does not have the “play list name” (FIG. 3) set thereto as yet.

As described above, the user can produce a play list principally by two operations including an operation of selecting a photo album and another operation of selecting a tune of BGM.

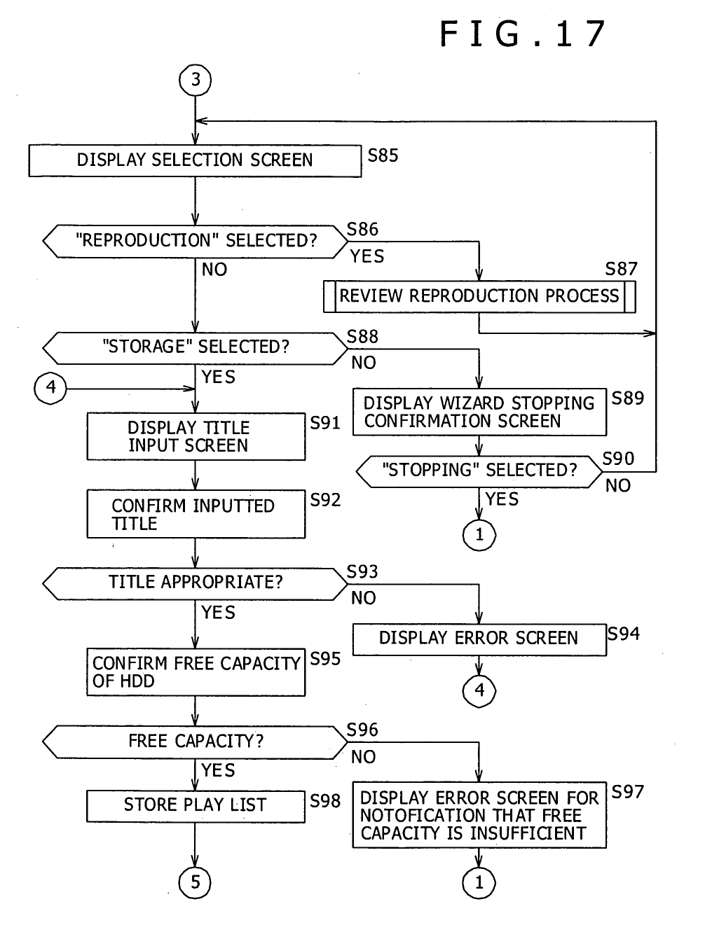

When a play list is produced, the output control section 136 causes a selection screen, on which preview reproduction of the play list or storage of the play list can be selected, to be displayed at step S85 (FIG. 17).

FIG. 20 shows an example of the display screen displayed at step S85 of FIG. 17.

On the selection screen of FIG. 20, a reproduction button 231 to be operated in order to perform preview reproduction of the play list produced at step S84, a storage button 232 to be operated in order to store the play list and a stop button 233 to be operated when later processing is to be stopped are displayed.

At step S86, the play list production section 135 decides whether or not the reproduction button 231 of FIG. 20 is operated to select the preview reproduction. If the play list production section 135 decides that the preview reproduction is selected, then it outputs the play list produced by the process at step S84 to the reproduction section 134.

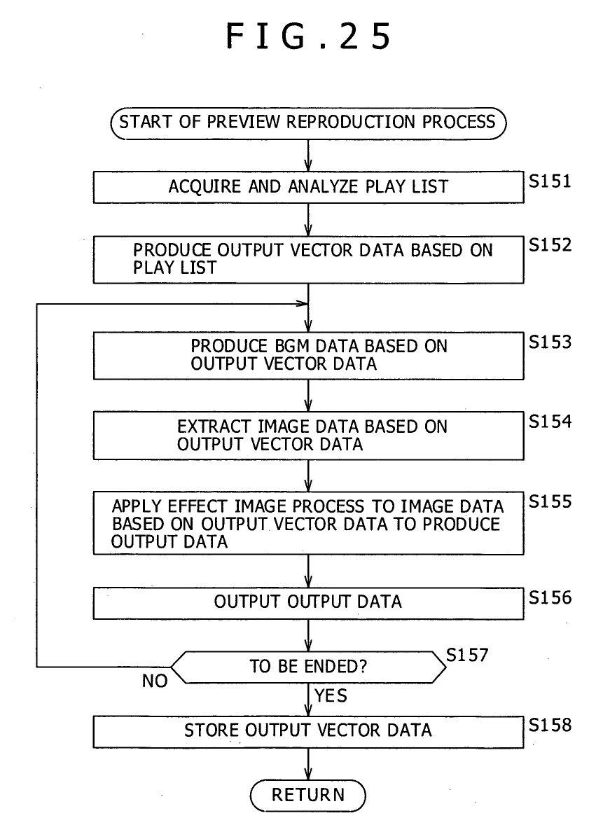

At step S87, a preview reproduction process is performed to reproduce the play list produced by the process at step S84. Consequently, the user can confirm what the still pictures to be reproduced in accordance with a reproduction procedure defined by the play list are. Details of the preview reproduction process are hereinafter described with reference to FIG. 25. When the preview reproduction process comes to an end, the processing returns to step S85 so that the processes at the steps beginning with step S86 are performed.

On the other hand, if the play list production section 135 decides at step S86 that preview reproduction of a play list is not selected, then the processing advances to step S88, at which the play list production section 135 decides whether or not the storage button 232 is operated to select storage of a play list.

If the play list production section 135 decides at step S88 that storage of a play list is not selected, then it decides that the stop button 233 is operated and notifies the output control section 136 of this. Thereafter, the processing returns to step S89.

At step S89, the output control section 136 causes a stopping confirmation screen of the wizard to be displayed.

On the stopping confirmation screen, for example, a message of “The production/modification of a play list is stopped. OK?” is displayed, and characters of “Yes” and “No” are displayed below the message. The user can end the production of a play list by selecting the characters of “Yes” but can continue the production of a play list by selecting the characters of “No”.

At step S90, the output control section 136 decides whether or not stopping of production of a play list is selected. If the output control section 136 decides that the stopping is selected, then the processing returns to step S71 so that the processes at the steps beginning with step S71 are executed repetitively. On the other hand, if the output control section 136 decides at step S90 that the stopping is not selected, then the processing returns to step S85 so that the processes at the steps beginning with step S85 are executed.

On the other hand, if the play list production section 135 decides at step S88 that storage of a play list is selected, then it notifies the output control section 136 of this, whereafter the processing advances to step S91. When storage of a play list is selected, the play list produced by the process at step S84 is outputted from the play list production section 135 to the content management section 131.

At step S91, the output control section 136 causes an input screen of a title of a play list (play list name) to be displayed.

On the input screen, for example, a title input place at which a title inputted by the user is to be displayed is displayed, and a keyboard (software keyboard) is displayed below the title input place. The user can operate, for example, the key board to input a title of the play list.

When a title of the play list is inputted, the content management section 131 confirms the inputted title at step S92, whereafter the processing advances to step S93, at which the content management section 131 decides whether or not the title is appropriate.

If the content management section 131 decides at step S93 that the inputted title is not appropriate, then it notifies the output control section 136 of this, whereafter the processing advances to step S94. It is decided that the title is not appropriate, for example, when one of the play lists set already has the same title or when the inputted title includes a character whose use is inhibited or in a like case.

At step S94, the output control section 136 causes an error screen to be displayed which is for the notification that the inputted title is inappropriate.

For example, on the error screen which is displayed where a play list having the same title set thereto already exists, a message of “The inputted name is overlapping or illegal. Please change the title name.” is displayed.

On the other hand, on the error screen which is displayed when the inputted title includes a character whose use is inhibited, a message of “The following characters cannot be used.” and those characters which cannot be used are displayed in addition to a message same as the message displayed on the error screen described above.

After the error screen for the notification that the title is inappropriate is displayed, the processing returns to step S91, at which inputting of a title is performed again.

On the other hand, if the content management section 131 decides at step S93 that the inputted title is appropriate, then the processing advances to step S95, at which the free capacity of the HDD 120 is confirmed.

At step S96, the content management section 131 decides whether or not the HDD 120 has a free capacity sufficient to store the play list. If the content management section 131 decides that the HDD 120 does not have a sufficient free capacity, then it notifies the output control section 136 of this. Thereafter, the processing advances to step S97.

At step S97, the output control section 136 causes an error screen for the notification that the free capacity is insufficient to be displayed.

On the error screen, for example, a message of “The capacity of the hard disk is insufficient. Please delete unnecessary titles, tracks or photos. The production/modification of the play is ended.” is displayed.

After the error screen for the notification that the free capacity is insufficient, the processing returns to step S71 so that the processes at the steps beginning with step S71 are executed.

On the other hand, if the content management section 131 decides at step S96 that the free capacity sufficient to store the play list remains in the HDD 120, then the processing advances to step S98, at which it stores the produced play list as a content which belongs to “photo”. Consequently, an icon of the stored play list is displayed for “photo” of the menu screen.

FIG. 21 shows an example of the menu screen on which the play list is added as a content which belongs to “photo”.

On the screen of FIG. 21, category icons 191 to 194 and a category icon 211 are displayed in a horizontal array, and the category which is selected currently is “photo”. When “photo” is selected, an icon 241 representative of the play list stored by the process at step S88 of FIG. 17 is displayed below the category icon 191 as seen in FIG. 21. On the right side of the icon 241, “travel” which is the title of the play list is displayed.

In this manner, the play list is displayed as a content of “photo” similarly to another still picture content (photo album) on the menu screen. Accordingly, the user can select the play list in a similar feeling as upon selection of another still picture content and perform reproduction and so forth of the play list. On the screen of FIG. 21, content icons 242 and 243 displayed below the icon 241 represent photo albums. It is to be noted that not an icon representative of a play list may be displayed alongside an icon representative of a photo album but one folder may be displayed alongside an icon representative of a photo album while an icon of a produced play list is displayed in a hierarchy lower than that of the folder.

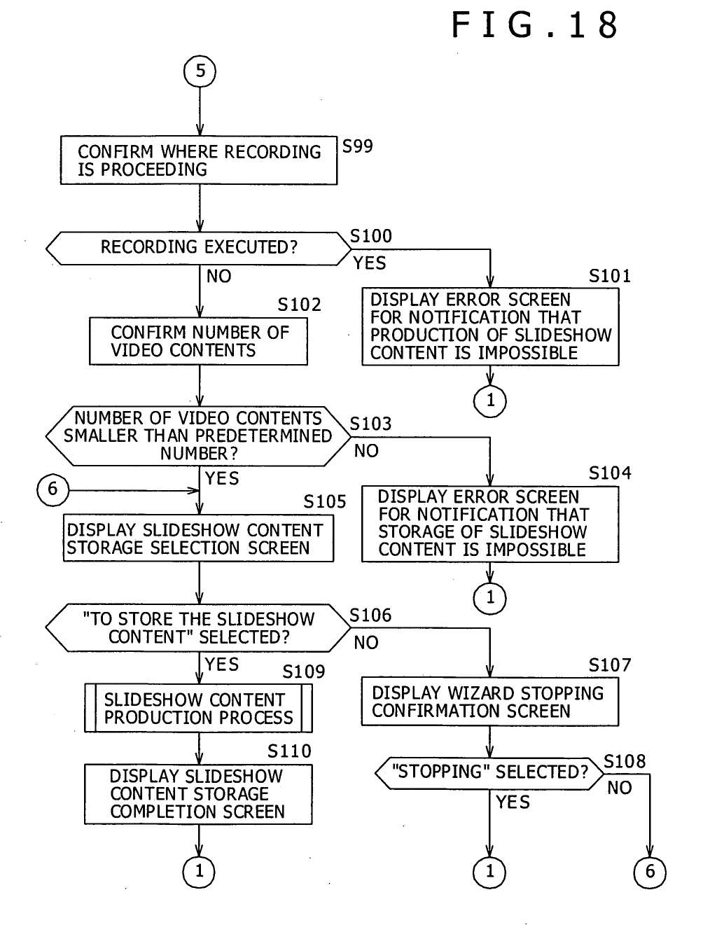

When the play list is stored, the content management section 131 confirms at step S99 (FIG. 18) whether or not recording of a television program is being performed by the recording/reproduction section 117.

As described hereinabove, in the information processing apparatus 1, output vector data which are equivalent to a result of reproduction of a play list can be stored as a content (slideshow content), and it is confirmed here whether or not production of a slideshow content is possible. When the recording/reproduction section 117 which performs MPEG2 encoding is executing MPEG2 encoding such as recording of a television program, production of a slideshow content which is considered as a content of the same type is impossible. Naturally, it is possible to eliminate such restriction. In other words, it is otherwise possible to omit the confirmation here.

At step S100, the content management section 131 decides whether or not the recording/reproduction section 117 is executing recording. If the content management section 131 decides that the recording/reproduction section 117 is executing recording, then it notifies the output control section 136 of this, whereafter the processing advances to step S101.

At step S101, the output control section 36 causes an error screen for the notification that production of a slideshow content cannot be performed to be displayed.

On the error screen, for example, a message of “The play list is stored. Video production cannot be carried out during recording. Please perform video production from the play list after the recording is ended. The play list production/modification is ended.” is displayed. The “video” in the message signifies a “slideshow content”.

After the error screen for the confirmation that a slideshow content cannot be produced is displayed, the processing returns to step S71 so that the processes at the steps beginning with step S71 are executed. The user can select the icon of the play list displayed as a content belonging to “photo” from within the menu screen and perform production of a slideshow content from a sub menu (a list of operations which can be performed using the play list) displayed in response to the selection of the icon. The “Please perform video production from the play list after the recording is ended.” from within the message displayed on the error screen represents this.

On the other hand, if the content management section 131 decides at step S100 that the recording/reproduction section 117 is not executing recording, that is, production of a slideshow content is possible, then the processing advances to step S102. At step S102, the content management section 131 confirms the number of video contents (including television programs and slideshow contents) stored in the HDD 120. In particular, in the present example, an upper limit is set to the number of video contents which can be stored in the HDD 120, and when a number of video contents equal to the upper limit number are stored already, storage of any more video content is inhibited.

At step S103, the content management section 131 decides whether or not the number of video contents is equal to or smaller than a predetermined number. If the content management section 131 decides that the number of video contents is not smaller than the predetermined number (reaches the upper limit number), then it notifies the output control section 136 of this, and the processing advances to step S104.

At step S104, the output control section 136 causes an error screen for the notification that production (storage) of a slideshow content is impossible to be displayed.

On the error screen, a message of “Full titles exist. Please delete unnecessary titles, tracks and photos. The play list production/modification is ended.” is displayed.

After the error screen for the notification that production of a video content is impossible is displayed, the processing returns to step S71 so that the processes at the steps beginning with step S71 are executed.

On the other hand, if the content management section 131 decides at step S103 that the number of video contents is equal to or smaller than the predetermined number, then it notifies the output control section 136 of this, and the processing advances to step S105.

At step S105, the output control section 136 causes a selection screen for the selection of whether or not the slideshow content should be stored to be displayed.

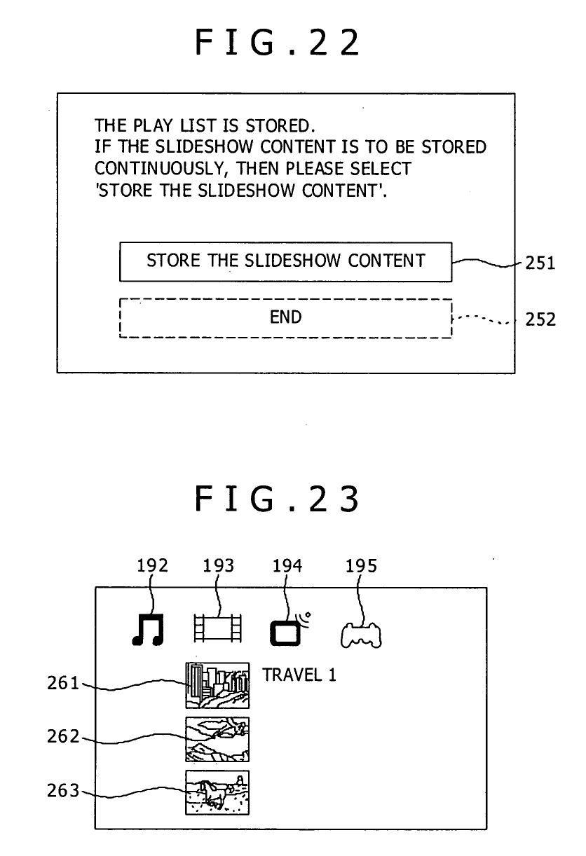

FIG. 22 shows an example of the selection screen displayed at step S105 of FIG. 18.

On the screen of FIG. 22, a message of “The play list is stored. If the slideshow content is to be stored continuously, then please select ‘store the slideshow content’.” is displayed.

Further, at a lower portion of the screen of FIG. 22, a GUI button 251 on which characters “store the slideshow content” to be selected when a slideshow content is to be stored and another GUI button 252 on which characters of “end” for ending the process without storing the slideshow content are displayed. The user can store the slideshow content into the HDD 120 by operating the remote controller to select the GUI button 251 on which the characters “Store the slideshow content” are displayed.

At step S106, the content management section 131 decides whether or not the characters “Store the slideshow content” are selected from within the selection screen of FIG. 22,. If the content management section 131 decides that the characters “store the slideshow content” are not selected, that is, if the content management section 131 decides that the characters “End” are selected from within the selection screen of FIG. 22, then it notifies the output control section 136 of this. Thereafter, the processing advances to step S107.

At step S107, the output control section 136 causes a stopping confirmation screen of the wizard to be displayed. The stopping confirmation screen displayed here is same as the screen displayed at step S89 of FIG. 17.

At step S108, it is decided whether or not stopping of the wizard is selected from within the stopping confirmation screen. If it is decided that the stopping is selected, then the processing returns to step S71 so that the processes at the steps beginning with step S71 are executed. On the other hand, if it is decided at step S108 that the stopping of the wizard is not selected, then the processing returns to step S105, at which it is selected again whether or not the slideshow content should be stored.

On the other hand, if the content management section 131 decides at step S106 that the characters of “store the slideshow content” are selected from within the selection screen of FIG. 22, then the processing advances to step S109.

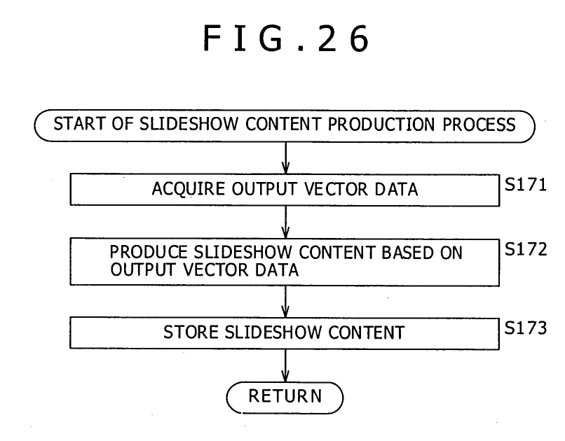

At step S109, a slideshow content production process is performed. The slideshow content produced by the slideshow content production process is outputted from the slideshow content production section 133 to the content management section 131 and stored into the HDD 120. Details of the slideshow content production process are hereinafter described with reference to a flow chart of FIG. 26.

At step S110, the output control section 136 causes a storage completion screen for the notification that storage of the slideshow content is completed to be displayed.

On the storage completion screen, for example, a message for the notification that the slideshow content produced by the process at step S109 is stored as one of contents which belong to “video” is displayed.

Consequently, to “video” on the menu screen, an icon representative of the slideshow content is displayed additionally.

FIG. 23 shows an example of the menu screen on which an icon representative of the slideshow content is added as an icon of a content which belongs to “video”.

On the screen of FIG. 23, category icons 192 to 195 are displayed in a horizontal array, and the currently selected category is “video”. At this time, an icon 261 representative of the slideshow content is displayed below the category icon 193 as seen in FIG. 23.

On the right side of the icon 261, “Travel 1” which is a title of the slideshow content is displayed. In particular, the slideshow content represented by the icon 261 of FIG. 23 is produced from a result of reproduction of the play list represented by the icon 241 of FIG. 21, and the same title as that of the play list represented by the icon 241 of FIG. 21 is set to the slideshow content.

In this manner, the slideshow content produced from a result of reproduction of the play list is displayed as a content belonging to “video” similarly to the other video contents such as a television program on the menu screen. Accordingly, the user can select the slideshow content in a same feeling as that upon selection of any other video content and perform reproduction and so forth of the slideshow content. On the screen of FIG. 23, content icons 262 and 263 displayed below the icon 261 represent video contents of television programs.

It is to be noted that the user may write (record) the slideshow content on the optical disk 125 or transmit the slideshow content to another apparatus through the communication section 121 similarly to any other video content of a television program. Accordingly, the user can load the optical disk 125 on which the slideshow content is recorded into another player or the like to enjoy the slideshow content.

In such a series of processes relating to a slideshow file as described above, the various processes described hereinabove with reference to the flow charts of FIGS. 9 to 11 are executed. Consequently, in the play list production process of the information processing apparatus 1 described hereinabove with reference to the flow charts of FIGS. 16 to 18, the information processing apparatus 1 can acquire still pictures (decoded image data) smoothly and can successively output the still pictures stably without a delay at output timings scheduled in advance.

Now, the play list production process performed at step S84 of FIG. 16 is described with reference to a flow chart of FIG. 24.

At step S131, the play list production section 135 acquires identification information such as the title of a photo album selected by the user, and then the processing advances to step S132. At step S132, the play list production section 135 acquires identification information of a tune of BGM selected by the user and identification information of a template coordinated with the tune. When the photo album is selected by the user, the title and so forth of the photo album are supplied from the content management section 131. Further, when the tune of BGM is selected by the user, identification information of the tune and identification information of the template coordinated with the tune are supplied from the BGM/template management section 132.

At step S133, the play list production section 135 produces a play list by describing the identification information of the photo album acquired at step S131 as “photo album” (FIG. 3) and describing the tune of BGM and the identification information of the template acquired at step S132 as “used tune” and “used template”, respectively. After the play list is produced, the processing returns to step S84 of FIG. 16 so that the processes at the steps beginning with step S84 are executed.

It is to be noted that, where “preferential image” is selected by the user, also describing of the same is performed. Further, “play list name” is described in the play list when a title is inputted by the user (when it is decided at step S93 of FIG. 17, that the inputted title is appropriate).

The play list produced through such processes as described above by the play list production section 135 is supplied to the reproduction section 134 when an instruction to perform preview reproduction of the play list is issued by the user. Further, when another instruction to store the play list is issued, the play list is supplied to the content management section 131.

Now, the preview reproduction process performed at step S87 of FIG. 17 is described with reference to a flow chart of FIG. 25. The preview reproduction process is performed based on a play list.

At step S151, the play list reproduction control section 141 (FIG. 7) acquires a play list supplied thereto from the play list production section 135, analyzes the play list and supplies information necessary for production of output vector data to the output vector data production section 142.

At step S152, the output vector data production section 142 produces output vector data based on the play list (information supplied thereto from the play list reproduction control section 141). The output vector data production section 142 supplies the produced output vector data to the BGM reproduction section 144, extraction section 145 and effect image processing section 146.

At step S153, the BGM reproduction section 144 acquires and reproduces BGM data based on the output vector data and supplies the BGM data to the effect image processing section 146 and so forth. At step S154, the extraction section 145 extracts image data (still pictures of an object of reproduction) from the photo album based on the output vector data and stores the image data into the internal memory 147.

At step S155, the effect image processing section 146 acquires image data from the internal memory 147 based on the output vector data and performs an effect image process for the image data to produce output data.

The processes executed by the buffer management section 148 and described hereinabove with reference to the flow charts of FIGS. 9 to 11 are performed corresponding to the process at step S155.

At step S156, the effect image processing section 146 outputs the produced output data to the output control section 136.

At step S157, the play list reproduction control section 141 decides whether or not the preview reproduction process should be ended. If it is decided that the preview reproduction process should not be ended, then the processing is returned to step S153 so that the processes at the steps beginning with step S153 are executed repetitively. On the other hand, if it is decided at step S157 that the preview reproduction process should be ended, then the play list reproduction control section 141 advances the processing to step S158. At step S158, the effect image processing section 146 stores the output vector data utilized for the production of the output data into the internal memory 147 and then ends the preview reproduction process. Thereafter, the processing is returned to step S87 in FIG. 17 so that the processes at the steps beginning with step S87 are executed.

In this manner, since still pictures to be outputted as a slideshow file are supplied stably without any delay from the internal memory 147 (buffer management section 148), the effect image processing section 146 can produce output data without a delay. In other words, the information processing apparatus 1 can successively output a plurality of data continuously in a stable state without a delay at output timings scheduled in advance.

Now, the slideshow content production process performed at step S109 of FIG. 18 is described with reference to a flow chart of FIG. 26. A slideshow content is produced from output vector data as described hereinabove. Further, the slideshow content production process is executed as a succeeding process of the play list reproduction process.

In particular, after the slideshow content production process is started in response to an instruction of the user or the like, the slideshow content production section 133 acquires output vector data held in the internal memory 147 of the reproduction section 134 at step S171.

After the output vector data are acquired, the slideshow content production section 133 produces a slideshow content by adding other information such as the title to the acquired output vector data at step S172. The produced slideshow content is supplied to the content management section 131.

At step S173, the content management section 131 supplies the slideshow content to the HDD 120 so as to be stored and then ends the slideshow content production process. Thereafter, the processing returns to step S109 of FIG. 18 so that the processes at the steps beginning with step S109 are executed.

After the slideshow content is stored in this manner, an icon representative of the slideshow content is added to “video” of the menu screen.

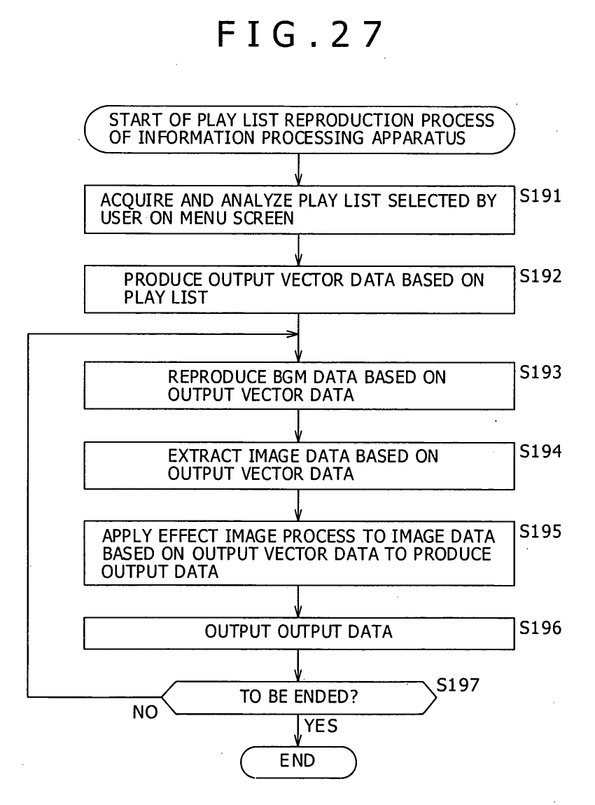

Now, the play list reproduction process performed by the information processing apparatus 1 is described with reference to a flow chart of FIG. 27.

This process is performed when an instruction to reproduce a play list produced by such a series of processes as described above is issued on the menu screen by the user. In other words, the play list reproduction process involves processes basically similar to those of the preview reproduction process described hereinabove with reference to the flow chart of FIG. 25.

In particular, at step S191, the play list reproduction control section 141 (FIG. 7) acquires a play list selected from within the menu screen by the user, analyzes the play list and supplies information necessary for production of output vector data to the output vector data production section 142. This process corresponds to the process at step S151 of FIG. 25.

At step S192, the output vector data production section 142 produces output vector data based on the play list (information supplied from the play list reproduction control section 141). The output vector data production section 142 supplies the produced output vector data to the BGM reproduction section 144, extraction section 145 and effect image processing section 146. This process corresponds to that at step S152 of FIG. 25.

At step S193, the BGM reproduction section 144 acquires and reproduces BGM data based on the output vector data and supplies the reproduced BGM data to the effect image processing section 146 and so forth. This process corresponds to the process at step S153 of FIG. 25. At step S194, the extraction section 145 extracts image data (still pictures of an object of reproduction) from the photo album based on the output vector data and stores the image data into the internal memory 147. This process corresponds to the process at step S154 of FIG. 25.

At step S195, the effect image processing section 146 acquires image data from the internal memory 147 based on the output vector data and performs an effect image process for the image data to produce output data. This process corresponds to the process at step S155 of FIG. 25.

The processes executed by the buffer management section 148 and described with reference to the flow charts of FIGS. 9 to 11 are performed corresponding to the process at step S195.

At step S196, the effect image processing section 146 outputs the produced output data to the output control section 136. This process corresponds to the process at step S156 of FIG. 25.

At step S197, the play list reproduction control section 141 decides whether or not the play list reproduction process should be ended. If it is decided that the play list reproduction process should not be ended, then the processing is returned to step S193 so that the processes at the steps beginning with step S193 are executed repetitively. On the other hand, if it is decided at step S197 that the play list reproduction process should be ended, then the play list reproduction control section 141 ends the play list reproduction process.

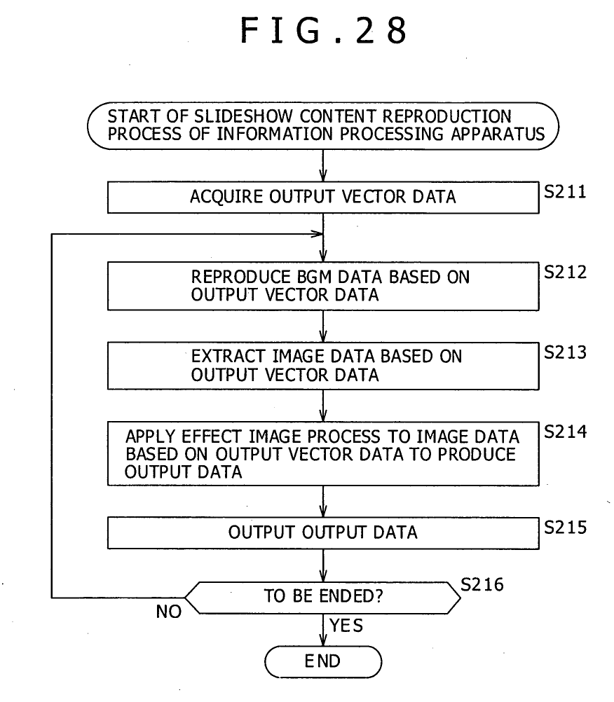

Now, a reproduction process of a slideshow content performed by the information processing apparatus 1 is described with reference to a flow chart of FIG. 28.

This process is performed when an instruction to reproduce a slideshow content produced through such a series of processes as described above is issued on the menu screen by the user. In particular, also the slideshow content reproduction process involves processes basically similar to those of the play list reproduction process described above with reference to the flow chart of FIG. 27.

It is to be noted, however, that, in the present slideshow content reproduction process, not a play list but a slideshow content (output vector data) is utilized.

Accordingly, the slideshow content reproduction control section 143 (FIG. 7) acquires, at step S211, a slideshow content selected on the menu screen by the user and acquires output vector data included in the slideshow content. Then, the slideshow content reproduction control section 143 supplies the acquired output vector data to the BGM reproduction section 144, extraction section 145 and effect image processing section 146. This process corresponds to steps S191 and S192 of FIG. 27.

At step S212, the BGM reproduction section 144 acquires and reproduces BGM data based on the output vector data and supplies the BGM data to the effect image processing section 146 and so forth. This process corresponds to the process at step S193 of FIG. 27. At step S213, the extraction section 145 extracts image data (still pictures of a reproduction object) from the photo album based on the output vector data and stores the image data into the internal memory 147. This process corresponds to the process at step S194 of FIG. 27.

At step S214, the effect image processing section 146 acquires image data from the internal memory 147 based on the output vector data and performs an effect image process for the image data to produce output data. This process corresponds to the process at step S195 of FIG. 27.

The processes executed by the buffer management section 148 and described hereinabove with reference to the flow charts of FIGS. 9 to 11 are performed corresponding to the process at step S214.

At step S215, the effect image processing section 146 outputs the produced output data to the output control section 136. This process corresponds to the process at step S196 of FIG. 27.

At step S216, the slideshow content reproduction control section 143 decides whether or not the slideshow content reproduction process should be ended. If the slideshow content reproduction process should not be ended, then the processing returns to step S212 so that the processes at the steps beginning with step S212 are executed repetitively. On the other hand, if it is decided at step S216 that the slideshow content reproduction process should be ended, then the slideshow content reproduction control section 143 ends the slideshow content reproduction processes.

Consequently, the user can enjoy the slideshow content in a feeling similar to that upon enjoyment of other video contents such as a television program.

As described above, the information processing apparatus 1 can successively output a plurality of data continuously in a stable state without a delay at output timings scheduled in advance without increasing the cost. Further, while it is conventionally necessary to produce a series of data of a slideshow file wherein an effect is applied to still pictures in advance because it is actually difficult to achieve such slideshow that still pictures are successively displayed with an effect applied thereto because of an influence of a delay in decoding process and so forth, the necessity for such production of data in advance as just described is eliminated by such a configuration as provided by the present invention.

While, in the foregoing description, tunes to be used as BGM are prepared in advance in the information processing apparatus 1, the information processing apparatus 1 may be configured otherwise such that tunes fetched into the information processing apparatus 1 from a music CD or the like by the user may be selected as BGM.

When a tune is fetched into the information processing apparatus 1 from a music CD, also attribute information such as a tempo or a genre of the fetched tune is fetched into the information processing apparatus 1 from the music CD or from a predetermined server connected through a network, and a template of an effect suitable for the fetched tune is coordinated in accordance with an atmosphere of the tune determined from the attribute information. The coordination of the tune and the template is performed based, for example, on the attribute information of the tune and information of the “atmosphere” of the template of FIG. 4.

Consequently, the user can select a tune fetched into the information processing apparatus 1 by the user itself as BGM. Further, since a template is coordinated automatically with the fetched tune, the user can select also a template only by selecting a tune to be used as BGM.

It is to be noted that also a template itself coordinated with a tune is not prepared in advance in the information processing apparatus 1 but may be downloaded from a server connected through a network or may be fetched through the optical disk 125 or the like.

Further, in the foregoing, one effect (template) is coordinated with one tune of BGM, and a still picture is reproduced in such a form that one tune selected as BGM has one coordinated effect applied thereto. However, one tune of BGM may have a plurality of effects coordinated therewith which are suitable for the atmosphere of the tune. In this instance, the user may select a desired one of the effects after selection of BGM.

While the series of processes described above can be executed by hardware, it may otherwise be executed by software.

Where the series of processes described above are executed by software, a program which constructs the software is installed from a network or a recording medium into a computer incorporated in hardware for exclusive use or, for example, a personal computer for universal use which can execute various functions by installing various programs.

The recording medium may be formed as a memory card 123 or an optical disk 125 which has the program recorded thereon or therein and is distributed in order to provide the program to a user separately from an apparatus body, or as a ROM 112 or a hard disk included in a HDD 120 which has the program recorded therein or thereon and is provided to a user in a form wherein it is incorporated in an apparatus body in advance.

It is to be noted that, in the present specification, the steps may not be necessarily processed, as well as may be processed, in a time series in the order as described, and include processes which are executed in parallel or individually without being processed in a time series.

While preferred embodiments of the present invention have been described using specific terms, such description is for illustrative purposes only, and it is to be understood that changes and variations may be made without departing from the spirit or scope of the following claims.

What is claimed is:

1. An information processing apparatus for processing image data, comprising:
a reproduction control section for controlling image data so as to be reproduced successively at predetermined timings determined in advance;
a storage section for storing first image data before reproduced by said reproduction control section and second image data after reproduced by said reproduction control section; and
an image data management section for managing inputting and outputting of the image data stored in said storage section and supplying the first image data stored in said storage section to said reproduction control section but supplying, where the number of first image data to be supplied to said reproduction control section is insufficient, the second image data to said reproduction control section.

2. The information processing apparatus according to claim 1, further comprising a setting section for setting a maximum total number of the first and second image data which can be stored in said storage section and a maximum number of the second image data which can be stored in said storage section, said image data management section managing inputting and outputting of the image data stored in said storage section so that the number of the stored image data may not exceed the maximum number set by said setting section.

3. The information processing apparatus according to claim 1, further comprising a decoding section for decoding image data encoded in accordance with a predetermined system, said image data management section causing said storage section to store the image data decoded by said decoding section as the first image data.

4. The information processing apparatus according to claim 1, further comprising a status management section for managing transition of the status of the image data stored in said storage section, said status management section setting the statuses of the first and second data so as to be different from each other, said image data management section identifying the first and second data from each other based on the statuses.

5. An information processing method for an information processing apparatus for processing image data, comprising the steps of:
controlling a reproduction section of said information processing apparatus to reproduce image data successively at predetermined timing determined in advance; and
managing inputting and outputting of the image data stored in a storage section adapted to store first image data before reproduced by the process of the reproduction control step and second image data after reproduced by the process of the reproduction control step and supplying the first image data stored in said storage section to said reproduction section but supplying, where the number of the first image data to be supplied to said reproduction section is insufficient, the second image data to said reproduction section.

6. A program for causing a computer to perform a process regarding image data, comprising the steps of:
controlling a reproduction section connected to said computer to reproduce image data successively at predetermined timing determined in advance; and
managing inputting and outputting of the image data stored in a storage section of said computer adapted to store first image data before reproduced by the process of the reproduction control step and second image data after reproduced by the process of the reproduction control step and supplying the first image data stored in said storage section to said reproduction section but supplying, where the number of the first image data to be supplied to said reproduction section is insufficient, the second image data to said reproduction section.
